(19) United States
(12) Patent Application Publication
(10) Pub. No.: US 2024/0111080 A1
(43) Pub. Date: Apr. 4, 2024

(54) ELECTROMAGNETIC DIELECTRIC POLARIZER

(71) Applicant: ROGERS CORPORATION, Chandler, AZ (US)

(72) Inventors: Gianni TARASCHI, Arlington, MA (US); Daniel PENNOCK, Salem, MA (US); Jennifer BAILEY, North Chelmsford, MA (US)

(21) Appl. No.: 18/374,430

(22) Filed: Sep. 28, 2023

Related U.S. Application Data
(60) Provisional application No. 63/412,739, filed on Oct. 3, 2022.

(51) Int. Cl. G02B 5/30

(52) U.S. Cl. CPC G02B 5/3008; G02B 5/3033

(57) ABSTRACT

A dielectric polarizer for electromagnetic applications, includes: a monolithic body of Dk material having a plurality of linear elongated ribs disposed parallel with each other; wherein each rib of the plurality of linear elongated ribs has a cross section x-z profile relative to an orthogonal X-Y-Z coordinate system; wherein the Y-direction of the coordinate system is oriented in a direction of elongation of the plurality of linear elongated ribs; wherein the Z-direction of the coordinate system is oriented in a direction of propagation of an EM wave through the uniformly spaced apart plurality of linear elongated ribs; wherein the monolithic body has an overall thickness dimension, T, aligned in the Z-direction, that extends from a first side to a second side of the body; wherein adjacent ones of the plurality of linear elongated ribs are monolithically connected to each other by a plurality of connecting bridges.

### CROSS REFERENCE TO RELATED APPLICATIONS

This application claims the benefit of U.S. Provisional Application Ser. No. 63/412,739, filed 3 Oct. 2022, which is incorporated herein by reference in its entirety.

### BACKGROUND

The present disclosure relates generally to an electromagnetic, EM, dielectric polarizer, and particularly to an EM polarizer capable of being extruded or molded.

Existing EM polarizers can be found in at least the following references: MM Wave Transmission Polarizer, L. L. Goldstone, IBM Corp., Federal System Division, Owego, New York, AP 7(c) 11-3, CH1456-3/79/0000-0606, 1979, IEEE; A Wideband Millimeter-Wave Circularly Polarized Antenna With 3-D Printed Polarizer, Kai Xu Wang, Hang Wong, IEEE Transactions On Antennas And Propagation, Vol. 65, No. 3, March 2017; Low-Profile Planar Dielectric Polarizer Using High-Dielectric-Constant Material and Anisotropic Antireflection Layers, Chen Ding, Kwai-Man Luk, IEEE Transactions On Antennas And Propagation, Vol. 69, No. 12, December 2021; Low-Cost Circularly Polarized Millimeter-Wave Antenna Using Additive Manufacturing Dielectric Polarizer, Yazan Al-Alem, Syed M. Sifat, Yahia M. M. Antar, Ahmed A. Kishk, Gaozhi (George) Xiao, 978-1-7281-4670-6/21, 2021, IEEE.

While existing EM polarizers may be suitable for their intended purpose, the art relating to such would be advanced with an EM dielectric polarizer having a robust construct that can be readily fabricated using extruding or molding techniques.

### BRIEF SUMMARY

An embodiment includes a dielectric, Dk, polarizer for EM applications as defined by the appended independent claim(s). Further advantageous modifications of the Dk polarizer for EM applications are defined by the appended dependent claims.

In an embodiment, a dielectric, Dk, polarizer for electromagnetic, EM, applications, comprises: a monolithic body of Dk material comprising a plurality of linear elongated ribs that are disposed parallel with each other and that are uniformly spaced apart with respect to each other; wherein each rib of the plurality of linear elongated ribs has a cross section x-z profile relative to an orthogonal X-Y-Z coordinate system associated with the monolithic body; wherein the Y-direction of the coordinate system is oriented in a direction of elongation of the plurality of linear elongated ribs; wherein the Z-direction of the coordinate system is oriented in a direction of propagation of an EM wave, when present at the Dk polarizer, through the uniformly spaced apart plurality of linear elongated ribs; wherein the monolithic body has an overall thickness dimension, T, aligned in the Z-direction, that extends from a first side to a second side of the body, the second side being at dimension T relative to the first side; wherein adjacent ones of the plurality of linear elongated ribs are monolithically connected to each other by a plurality of connecting bridges; wherein the plurality of connecting bridges are disposed at a location equal to or greater than T/2 and equal to or less than T.

In an embodiment, the foregoing Dk polarizer further comprises: at least one plurality of EM anti-reflection features monolithically connected to and disposed: on the bottom of the plurality of linear elongated ribs; on the top of the plurality of linear elongated ribs; or, on both the bottom and the top of the plurality of linear elongated ribs.

In an embodiment, the foregoing Dk polarizer further comprises: at least one EM anti-reflection layer connected to and disposed: on the bottom of the plurality of linear elongated ribs; on the top of the plurality of linear elongated ribs; or, on both the bottom and the top of the plurality of linear elongated ribs.

In an embodiment, the foregoing Dk polarizer further comprises: at least one plurality of Dk spacers monolithically connected to and disposed: on the bottom of more than one of the plurality of linear elongated ribs; on top of the plurality of connecting bridges and disposed vertically over, in the Z-direction, more than one of the plurality of linear elongated ribs; or, on the bottom of more than one of the plurality of linear elongated ribs, and on top of the plurality of connecting bridges and disposed vertically over, in the Z-direction, more than one of the plurality of linear elongated ribs; and at least one EM anti-reflection layer connected to the at least one plurality of Dk spacers.

In an embodiment, the foregoing Dk polarizer further comprises: at least one plurality of Dk spacers connected to and disposed: on the bottom of more than one of the plurality of linear elongated ribs; on top of the plurality of connecting bridges and disposed vertically over, in the Z-direction, more than one of the plurality of linear elongated ribs; or, on the bottom of more than one of the plurality of linear elongated ribs, and on top of the plurality of connecting bridges and disposed vertically over, in the Z-direction, more than one of the plurality of linear elongated ribs; and at least one EM anti-reflection layer monolithically connected to the at least one plurality of Dk spacers.

In an embodiment, the foregoing Dk polarizer further comprises: at least one plurality of Dk spacers connected to and disposed: on the bottom of more than one of the plurality of linear elongated ribs, wherein each Dk spacer of the at least one plurality of Dk spacers bridges across at least two adjacent ones of the plurality of linear elongated ribs; on top of the plurality of connecting bridges and disposed vertically over, in the Z-direction, more than one of the plurality of linear elongated ribs; or, on the bottom of more than one of the plurality of linear elongated ribs, wherein each Dk spacer of the at least one plurality of Dk spacers bridges across at least two adjacent ones of the plurality of linear elongated ribs, and on top of the plurality of connecting bridges and disposed vertically over, in the Z-direction, more than one of the plurality of linear elongated ribs; and at least one EM anti-reflection layer connected to the at least one plurality of Dk spacers.

In an embodiment, the foregoing Dk polarizer further comprises: at least one Dk spacer layer connected to and disposed: on the bottom of the more than one plurality of linear elongated ribs, and bridging across multiple adjacent ones of the plurality of linear elongated ribs; on top of the plurality of connecting bridges, and bridging across multiple adjacent ones of the plurality of linear elongated ribs; or, on the bottom of the more than one plurality of linear elongated ribs, and bridging across multiple adjacent ones of the plurality of linear elongated ribs, and on top of the plurality of connecting bridges, and bridging across multiple adjacent ones of the plurality of linear elongated ribs; and at least one EM anti-reflection layer connected to and disposed on the at least one Dk spacer.

In an embodiment, the foregoing Dk polarizer further comprises: at least one Dk support frame disposed around an outer perimeter of the monolithic body and being monolithically formed with the plurality of connecting bridges, the at least one Dk support frame: extending down below a distal end of the plurality of linear elongated ribs; extending above the plurality of connecting bridges; or, extending down below a distal end of the plurality of linear elongated ribs, and extending above the plurality of connecting bridges; and at least one EM anti-reflection layer connected to the at least one Dk support frame.

In an embodiment, the foregoing Dk polarizer is operational at a defined frequency having an associated wavelength k, wherein: a distance in the X-direction from the center of one of the plurality of linear elongated ribs to the center of an adjacent one of the plurality of linear elongated ribs defines a unit cell dimension, wherein the unit cell dimension is equal to or less than λ/2.

In an embodiment, a method of making the foregoing Dk polarizer comprises: molding the monolithic body via a single-axis mold that closes and opens along the Z-direction.

In an embodiment, a Dk polarizer assembly comprises: a plurality of the foregoing Dk polarizer arranged side-by-side one another in a tiled arrangement.

The above features and advantages and other features and advantages of the invention are readily apparent from the following detailed description of the invention when taken in connection with the accompanying drawings.

### BRIEF DESCRIPTION OF THE DRAWINGS

Referring to the exemplary non-limiting drawings wherein like elements are numbered alike, and where like elements are illustrated alike, in the accompanying Figures:

FIG. 1A depicts a rotated isometric view of a first embodiment of a Dk polarizer, having a continuous planar form of connecting bridges, in accordance with an embodiment;

FIG. 1B depicts Detail 1B of FIG. 1A, in accordance with an embodiment;

FIG. 1C depicts an X-Z cross section view of Detail 1B of FIG. 1B, in accordance with an embodiment;

FIG. 1D depicts an X-Y cross section view of Detail 1B of FIG. 1B, in accordance with an embodiment;

FIG. 2A depicts a cross section side view through section cut 2A-2A of FIG. 1, and having connecting bridges disposed at a second side of the Dk polarizer, which is suitable for an extrusion manufacturing process, in accordance with an embodiment;

FIG. 2B depicts a cross section side view alternative to that of FIG. 2A, having connecting bridges disposed at a midway point between a first side and a second side of the Dk polarizer, which is suitable for an extrusion manufacturing process, in accordance with an embodiment;

FIG. 2C depicts a cross section side view alternative to that of FIG. 2A, having connecting bridges disposed at both a first side and a second side of the Dk polarizer, which is suitable for an extrusion manufacturing process, in accordance with an embodiment;

FIG. 2D depicts a cross section side view alternative to that of FIG. 2A, having connecting bridges disposed at various locations between the first side and the second side of the Dk polarizer, which is suitable for an extrusion manufacturing process, in accordance with an embodiment;

FIG. 2E depicts a cross section side view similar to that of FIG. 2A but with molding draft angles illustrated, in accordance with an embodiment;

FIG. 2F depicts a cross section side view of Detail 2F of FIG. 2E, in accordance with an embodiment;

FIG. 2G depicts another cross section side view alternative to that of FIG. 2A, and a rotated isometric view of Detail-2G of FIG. 2G, having EM antireflection features disposed at the first and second sides of the Dk polarizer, in accordance with an embodiment;

FIG. 2H depicts another cross section side view alternative to that of FIG. 2A, and a rotated isometric view of Detail-2H of FIG. 2H, having EM antireflection features disposed at the first and second sides of the Dk polarizer alternative to those of FIG. 2G, in accordance with an embodiment;

FIG. 2I depicts the cross section side view of FIG. 2A with EM antireflection features disposed on the first and second sides of the Dk polarizer alternative to those of FIGS. 2G and 2H, and a rotated isometric view of Detail-2I of FIG. 2I, in accordance with an embodiment;

FIG. 3A depicts a rotated isometric view of a second embodiment of a Dk polarizer, having a non-continuous planar form of connecting bridges, in accordance with an embodiment;

FIG. 3B depicts a top down plan view of the Dk polarizer of FIG. 3A, in accordance with an embodiment;

FIG. 3C depicts a rotated isometric view of an enlarged portion of Detail 3C of FIG. 3B, in accordance with an embodiment;

FIG. 3D depicts a top down plan view of a Dk polarizer similar to that of FIG. 3C with particular structural characteristics for a particular frequency operating range, in accordance with an embodiment;

FIG. 3E depicts a top down plan view of an enlarged portion of Detail 3E of FIG. 3D, in accordance with an embodiment;

FIG. 3F depicts the top down plan view of the enlarged portion of Detail 3E with cross section orientation depicted, in accordance with an embodiment;

FIG. 3G depicts a cross section side view through section cut 3G-3G of FIG. 3F, in accordance with an embodiment;

FIG. 4A depicts a top down plan view of a third embodiment of a Dk polarizer, having a continuous picture frame form of connecting bridges, in accordance with an embodiment;

FIG. 4B depicts a top down plan view of an enlarged portion of Detail 4B of FIG. 4A, in accordance with an embodiment;

FIG. 4C depicts a cross section side view through section cut 4C-4C of FIG. 4B, in accordance with an embodiment;

FIG. 4D depicts a rotated isometric view of the monolithic body of FIG. 3A with further illustration of a partial picture frame border, in accordance with an embodiment;

FIG. 4E depicts a rotated isometric view of an alternative monolithic body to that of FIG. 3A with illustration of a full picture frame border, in accordance with an embodiment;

FIG. 4F depicts a rotated isometric view of a segment of a rib depicted in FIG. 4A as Detail 4F having first side and second side EM antireflection features, in accordance with an embodiment;

FIG. 4G depicts a rotated isometric view of a segment of a rib depicted in FIG. 4A as Detail 4F having first side and second side EM antireflection features alternative to those of FIG. 4F, in accordance with an embodiment;

FIGS. 5A, 5B, 5C, 5D, 5E, and 5F, depict alternative ones of a cross section side view similar to that of FIG. 2A, but with alternative EM antireflection features spaced apart from the Dk polarizer, in accordance with an embodiment, and

FIG. 6 depicts a top down plan view of plurality of any one of the foregoing Dk polarizers of FIGS. 1A, 3A, 4A assembled in a tiled arrangement to form a Dk polarizer array, in accordance with an embodiment.

One skilled in the art will understand that the drawings, further described herein below, are for illustration purposes only. It will be appreciated that for simplicity and clarity of illustration, elements shown in the figures have not necessarily been drawn to scale. For example, the dimensions or scale of some of the elements may be exaggerated relative to other elements for clarity. Further, where considered appropriate, reference numerals may be repeated among the figures to indicate corresponding or analogous elements, or analogous elements may not be repetitively enumerated in all figures where it will be appreciated and understood that such enumeration where absent is inherently disclosed.

### DETAILED DESCRIPTION

As used herein, the phrase “embodiment” means “embodiment disclosed and/or illustrated herein”, which may not necessarily encompass a specific embodiment of an invention in accordance with the appended claims, but nonetheless is provided herein as being useful for a complete understanding of an invention in accordance with the appended claims.

Although the following detailed description contains many specifics for the purposes of illustration, anyone of ordinary skill in the art will appreciate that many variations and alterations to the following details are within the scope of the appended claims. For example, where described features may not be mutually exclusive of and with respect to other described features, such combinations of non-mutually exclusive features are considered to be inherently disclosed herein. Additionally, common features may be commonly illustrated in the various figures but may not be specifically enumerated in all figures for simplicity, but would be recognized by one skilled in the art as being an explicitly disclosed feature even though it may not be enumerated in a particular figure. Accordingly, the following example embodiments are set forth without any loss of generality to, and without imposing limitations upon, the claimed invention disclosed herein and in accordance with the appended claims.

An embodiment, as shown and described by the various figures and accompanying text, provides a Dk polarizer for EM applications having a robust construct that can be readily fabricated using extruding and/or molding techniques. In an embodiment, the Dk polarizer is configured to transform linearly polarized EM waves to circularly polarized EM waves, and vice versa. In an embodiment: a first Dk polarizer construct is capable of being extruded along the Y-axis of an orthogonal X-Y-Z coordinate system, and single-axis molded along the Z-axis; a second Dk polarizer construct is capable of being single-axis molded along the Z-axis, but not extruded; and, a third Dk polarizer is capable of being extruded along the Z-axis, and single-axis molded along the Z-axis.

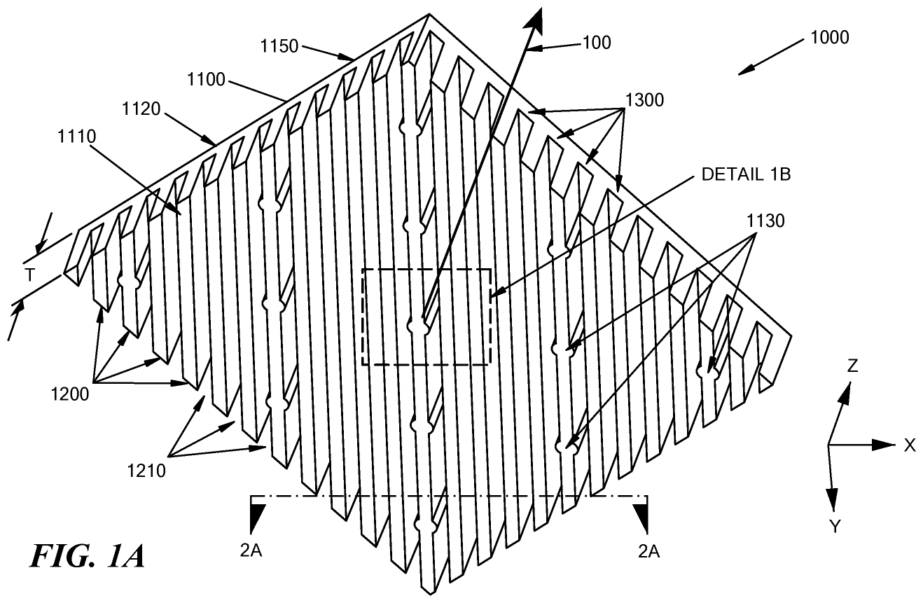

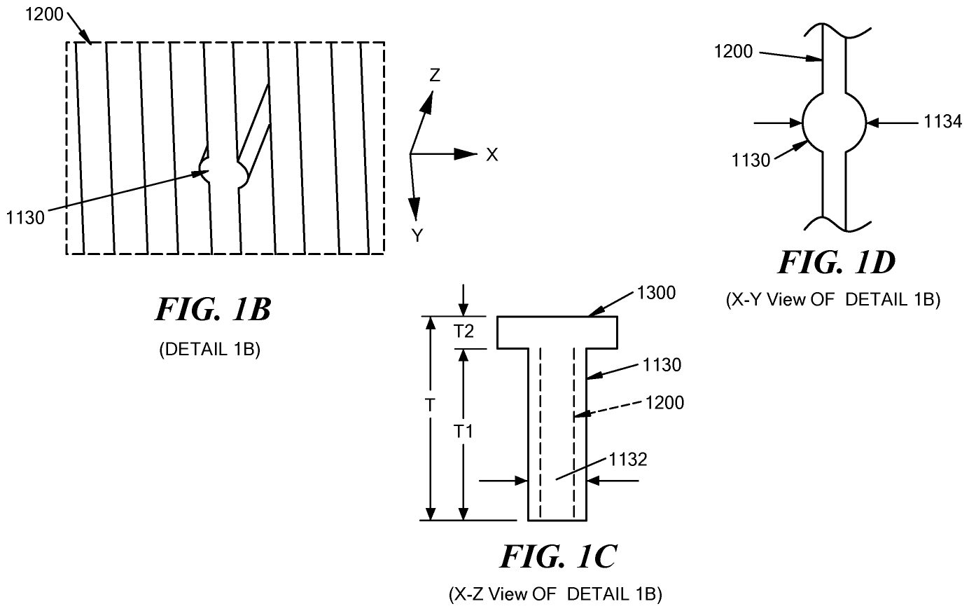

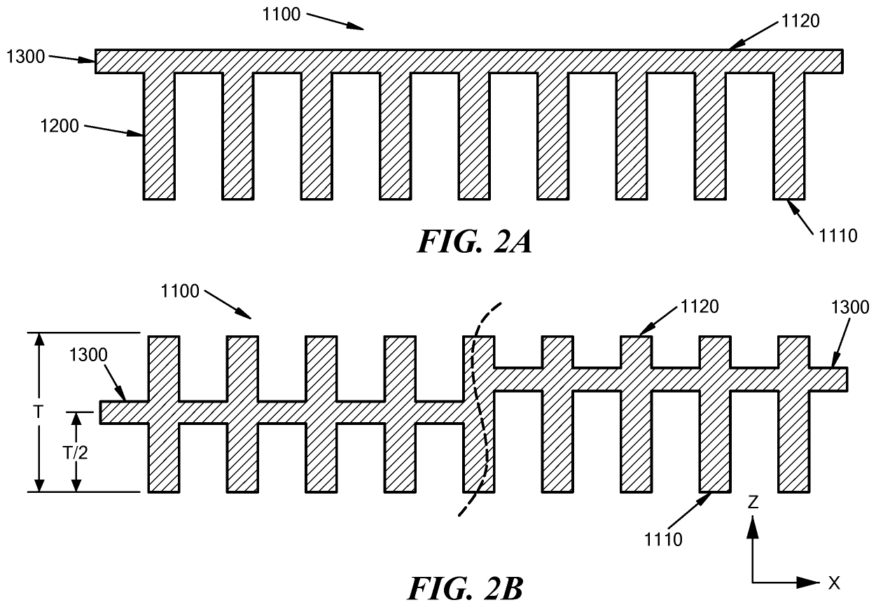

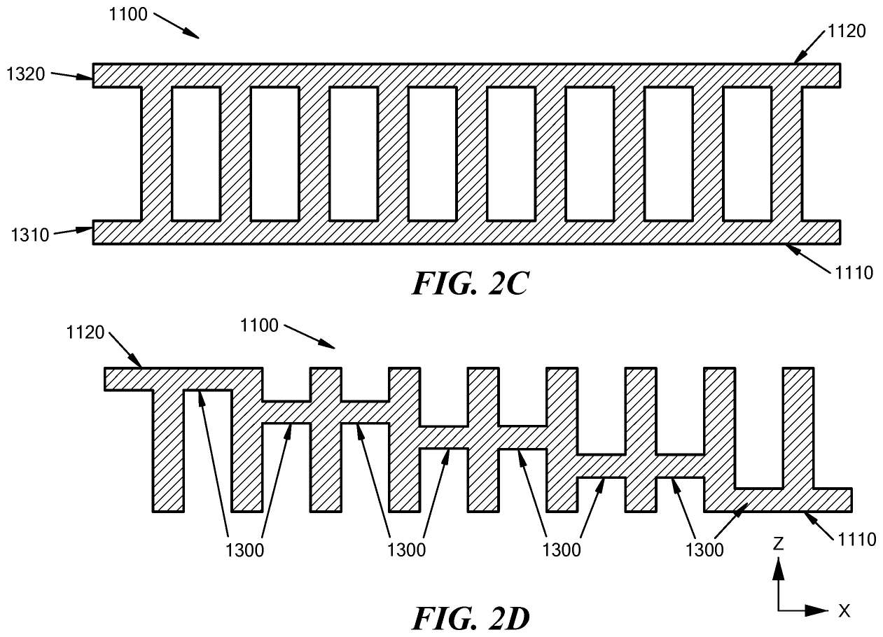

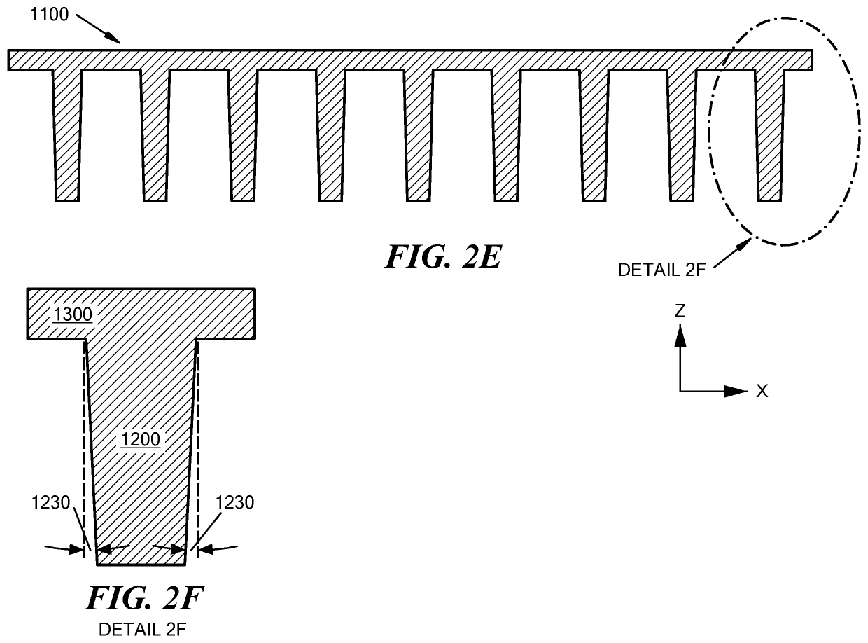

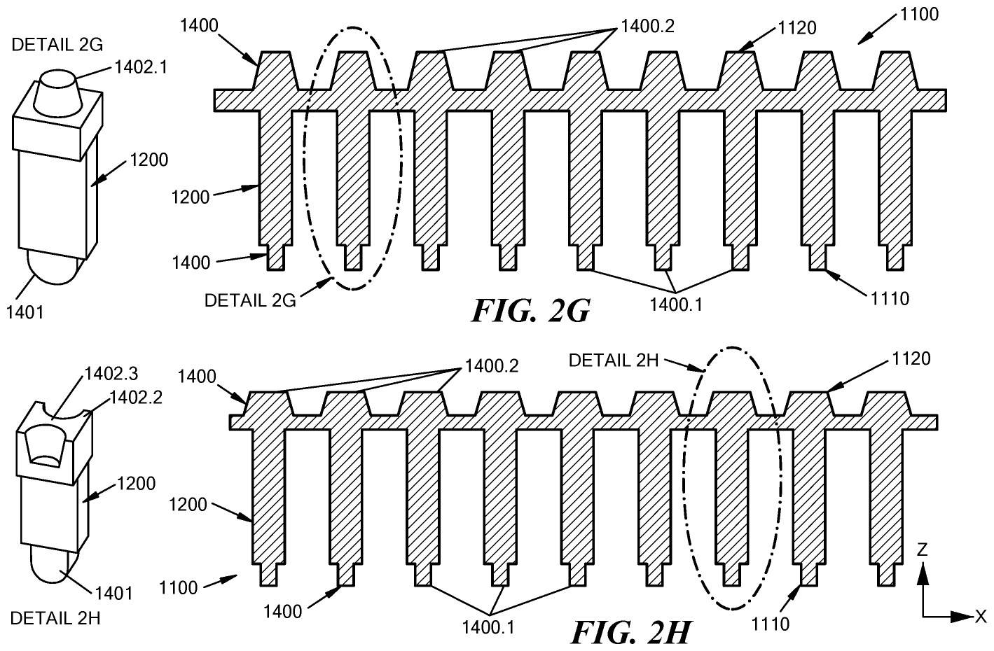

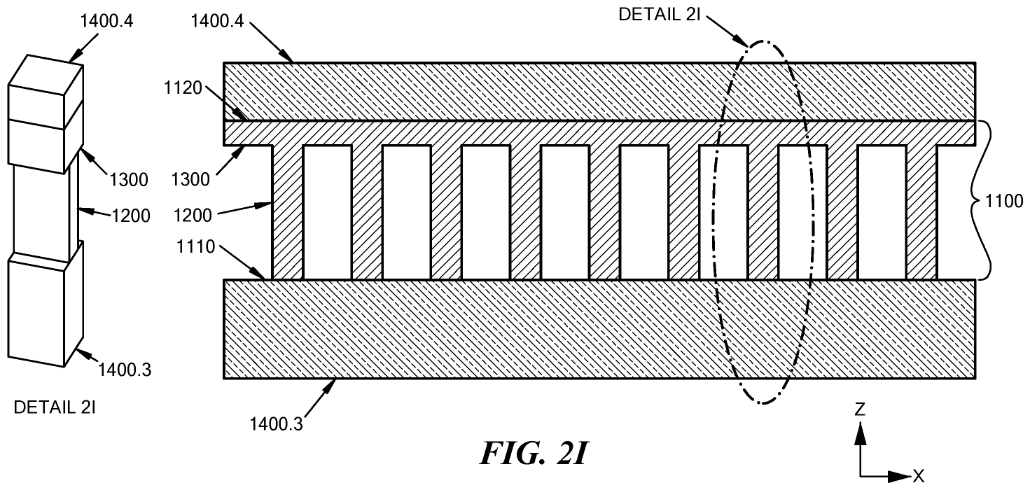

Reference is now made to FIGS. 1A-1D collectively, which depict a first embodiment of a Dk polarizer 1000 having a monolithic body 1100 of Dk material having a plurality of linear elongated ribs 1200 (individually referred to by the same reference numeral) that are disposed parallel with each other and that are uniformly spaced apart with respect to each other with an interstitial space 1210 disposed between each adjacent pair of linear elongated ribs 1200. In an embodiment, each rib of the plurality of linear elongated ribs 1200 has a cross section x-z profile relative to an orthogonal X-Y-Z coordinate system (see FIG. 1A) associated with the monolithic body 1100, wherein the X-direction of the coordinate system is oriented in a direction across (orthogonal to) the plurality of linear elongated ribs 1200, wherein the Y-direction of the coordinate system is oriented in a direction of elongation of the plurality of linear elongated ribs 1200, and wherein the Z-direction of the coordinate system is oriented in a direction of an overall thickness dimension, T, of the body 1100 and in a direction of propagation of an EM wave 100, when present at the Dk polarizer 1000, through the uniformly spaced apart plurality of linear elongated ribs 1200. In an embodiment, the EM wave 100, when present at the Dk polarizer 1000, also propagates through the interstitial spaces 1210 between the uniformly spaced apart plurality of linear elongated ribs 1200. In an embodiment, the overall thickness dimension, T, of the monolithic body 1100 is aligned in the Z-direction, and extends from a first side 1110 to a second side 1120 of the body 1100, the second side 1120 being at dimension T relative to the first side 1110. In an embodiment, adjacent ones of the plurality of linear elongated ribs 1200 are monolithically connected to each other by a plurality of connecting bridges 1300, wherein the plurality of connecting bridges 1300 are disposed at a location equal to or greater than T/2 and equal to or less than T (best seen with reference to FIGS. 2A-2D, discussed further below).

In an embodiment and with reference still to FIGS. 1A-1D, the body 1100 includes a plurality of push pins 1130 (individually referred to by the same reference numeral) to facilitate removal of the body 1100 from a cavity of a mold (not specifically shown but well known to one skilled in the art of molded constructs). For example, an embodiment includes an arrangement wherein the plurality of linear elongated ribs 1200 includes at least one region of push pins 1130 having an expanded x-z cross section 1132 (FIG. 1C) in conjunction with an expanded x-y cross section 1134 (FIG. 1D) relative to x-z and x-y cross sections of a non-expanded region of a corresponding linear elongated rib 1200. As can be seen from FIGS. 1A, 1B, and 1D, the at least one region of push pins 1130 has a partial circular profile in the X-Y plane (see ref. num. 1134 for example). However, it will be appreciated that an embodiment disclosed herein is not limited to a partial circular profile of the disclosed push pins 130, as the push pins may be of any shape suitable for a purpose disclosed herein. As can be seen from at least FIG. 1C, the Dk material of the at least one region of push pins 1130 extends the full height T1 of the corresponding linear elongated rib 1200. In an embodiment and as seen from FIG. 1C, each connecting bridge of the plurality of connecting bridges 1300 has an x-z cross section thickness T2 that is relatively thin in the Z-direction as compared to the x-z cross section height T1 of an associated linear elongated rib 1200 in the Z-direction. In an embodiment, the diameter (or outer dimension) 1134 of each push pin 1130 in the X-Y plane is greater than a width of a corresponding linear elongated rib 1200 and equal to or less than 1.5 times the width of a corresponding linear elongated rib 1200.

As can be seen with reference to at least FIG. 1A, an embodiment includes an arrangement where the plurality of connecting bridges 1300 form a solid surface at the second side 1120 of the thickness, T, the solid surface being absent of voids through the monolithic body 1100 in the Z-direction, which provides connecting bridges 1300 in the form of an unbroken thin sheet. In an embodiment, the plurality of connecting bridges 1300 have the construct of a continuous planar form of connecting bridges 1300. Additionally, an embodiment includes an arrangement where each end (see reference numeral 1110 for example) of the plurality of linear elongated ribs 1200 is open-ended, in that each respective end is not connected to a corresponding end of an adjacent one of the plurality of linear elongated ribs 1200.

In an embodiment, the monolithic body 1100 has a Dk constant equal to or greater than 2 and equal to or less than 4. In an embodiment, the monolithic body 1100 is operational at an EM frequency of 30 GHz to 100 GHz.

Reference is now made to FIGS. 2A-2F, which depict alternative locations for placing the plurality of connecting bridges 1300.

In an embodiment, the plurality of connecting bridges 1300 are disposed at the second side 1120 of the body 1100, as depicted in FIG. 2A. In another embodiment, the plurality of connecting bridges 1300 are disposed at a location of T/2, as depicted in the left side of FIG. 2B, or are disposed closer to the second side 1120 than to the first side 1110 of the body 1100, as depicted in the right side of FIG. 2B. While FIG. 2B depicts a left side and a right side having distinctly different placements of the plurality of connecting bridges 1300, it will be appreciated that this is for illustration purposes only, and that an embodiment may be constructed as illustrated, or may be constructed with all of the plurality of connecting bridges 1300 disposed in one of the illustrated arrangements or the other.

In an embodiment, and with reference to FIG. 2C, the plurality of connecting bridges 1300 may be composed of a first plurality of connecting bridges 1310 disposed at or proximate to the first side 1110 of the body, and a second plurality of connecting bridges 1320 disposed at or proximate to the second side 1120 of the body 1100.

From the foregoing, it will be appreciated that many arrangements for the plurality of connecting bridges 1300 relative to and between the first side 1110 and the second side 1120 of the body 1100 are possible, and that a given construct of the Dk polarizer 1000 as disclosed herein may have more than one of such arrangements, such as depicted in FIG. 2D for example. Any and all such arrangements for the plurality of connecting bridges 1300 relative to and between the first side 1110 and the second side 1120 of the body 1100 are contemplated and considered to be inherently if not explicitly disclosed herein.

Reference is now made to FIGS. 2E and 2F, where FIG. 2E depicts a cross section side view similar to that of FIG. 2A but with molding draft angles 1230 relative to the Y-Z plane illustrated, and FIG. 2F depicts an enlarged cross section side view of Detail 2F of FIG. 2E. In an embodiment, the draft angle 1230 is equal to or greater than 0.25-degrees and equal to or less than 30-degrees, or alternatively equal to or greater than 0.5-degrees and equal to or less than 5-degrees.

In an embodiment and with reference to FIGS. 2G and 2H, the body 1100 of the Dk polarizer 1000 includes antireflection features 1400 that serve to minimize or eliminate EM reflection within the body 1100 of the Dk polarizer 1000. Reference is now made to FIG. 2G with Detail-2G, and 2H with Detail-2H, which depict alternative arrangements of EM antireflection features 1400 monolithically formed with and disposed at the first and second sides 1110, 1120 of the body 1100 of the Dk polarizer 1000. As depicted in FIG. 2G, an embodiment includes at least one plurality of EM anti-reflection features 1400 monolithically connected to, formed with, and disposed: on the bottom (first side 1110 of the body 1100) of the plurality of linear elongated ribs 1200; on the top (second side 1120 of the body 1100) of the plurality of linear elongated ribs 1200; or, on both the bottom, first side 1110, and the top, second side 1120, of the plurality of linear elongated ribs 1200. In an embodiment, the at least one plurality of EM anti-reflection features 1400 includes a first plurality of EM anti-reflection features 1400.1 monolithically formed with and disposed on the bottom, first side 1110, of the plurality of linear elongated ribs 1200. In an embodiment, the at least one plurality of EM anti-reflection features 1400 includes a second plurality of EM anti-reflection features 1400.2 monolithically formed with and disposed on top, second side 1120, of the plurality of connecting bridges 1300 and disposed vertically over, in the Z-direction, the plurality of linear elongated ribs 1200. In an embodiment, each one of the second plurality of EM anti-reflection features 1400.2 is disposed in one-to-one correspondence with a corresponding one of the plurality of linear elongated ribs 1200. In an embodiment, and with reference to FIGS. 2G and 2H, each EM anti-reflection feature of the first plurality of EM anti-reflection features 1400.1 includes a projection 1401 having an x-z cross section dimension that is smaller in both the X-direction and the Z-direction than the x-z cross section of the corresponding linear elongated rib 1200. In an embodiment and as depicted in FIGS. 2G and 2H, the projection 1401 has a y-z cross section dimension that is smaller in both the Y-direction and the Z-direction than the y-z cross section of the corresponding linear elongated rib 1200. In an embodiment and with reference to FIG. 2G and Detail-2G, each EM anti-reflection feature of the second plurality of EM anti-reflection features 1400.2 includes a projection 1402.1 having an x-z cross section dimension that is smaller in the Z-direction than that of the x-z-cross section of the corresponding linear elongated rib 1200, and wherein adjacent ones of the second plurality of EM anti-reflection features 1400.2 do not directly touch each other. In an embodiment and as depicted in FIG. 2G, the projection 1402.1 has a y-z cross section dimension that is smaller in both the Y-direction and the Z-direction than the y-z cross section of the corresponding linear elongated rib 1200. In an embodiment and as depicted in FIG. 2H and Detail-2H, each EM anti-reflection feature of the second plurality of EM anti-reflection features 1400.2 includes a projection 1402.2 having an indentation 1402.3, where the indentation 1402.3 has a y-z cross section dimension that is smaller in both the Y-direction and the Z-direction than the y-z cross section of the corresponding linear elongated rib 1200. As can be seen by FIGS. 2G and 2H, the EM antireflection features 1400 may be composed of positive material, 1401, 1403.2, and 1402.2, for example, or positive and negative material, 1402.2 and 1402.3 for example, positive material being an additional presence of the material of the elongated rib 1200, and negative material being an absence of the material of the elongated rib 1200.

Reference is now made to FIG. 2I, which depicts the cross section side view of FIG. 2A with EM antireflection features 1400.3, 1400.4 (generally referred to by reference numeral 1400) disposed on the first and second sides 1110, 1120, respectively, of the body 1100 of the Dk polarizer 1000 alternative to the EM antireflection features 1400.1, 1400.2 depicted in FIGS. 2G and 2H. In an embodiment, the EM antireflection features 1400.3, 1400.4 are composed of at least one EM anti-reflection layer such as a first EM antireflection layer 1400.3, and a second EM antireflection layer 1400.4, connected to and disposed: on the bottom 1110 of the plurality of linear elongated ribs 1200; on the top 1120 of the plurality of linear elongated ribs 1200 via the plurality of connecting bridges 1300; or, on both the bottom 1110 and the top 1120 of the plurality of linear elongated ribs 1200. As depicted in FIG. 2I, the first EM antireflection layer 1400.3 is connected to and disposed on the bottom 1110 of the plurality of linear elongated ribs 1200, and the second EM antireflection layer 1400.4 is connected to and disposed on the top 1120 of the plurality of connecting bridges 1300 above the plurality of linear elongated ribs 1200, to which the plurality of connecting bridges 1300 are monolithically joined.

In an embodiment, the first EM anti-reflection layer 1400.3 covers an entire outside x-y area of the monolithic body 1100 as viewed from a top down plan view of the monolithic body 1100 (see Detail-2I for example), and in an embodiment is formed of a Dk material having a Dk constant that is less than the Dk constant of the Dk material of the monolithic body 1100. In an embodiment, the first EM anti-reflection layer 1400.3 is formed from a dielectric foam or a plastic, wherein the thickness in the Z-direction is tuned to minimize EM reflections.

In an embodiment, the second EM anti-reflection layer 1400.4 covers an entire outside x-y area of the monolithic body 1100 as viewed from a top down plan view of the monolithic body 1100 (see Detail-2I for example), and in an embodiment is formed of a Dk material having a Dk constant that is less than the Dk constant of the Dk material of the monolithic body 1100. In an embodiment, the second EM anti-reflection layer 1400.4 is formed from a dielectric foam or a plastic, wherein the thickness in the Z-direction is tuned to minimize EM reflections.

As can be seen with reference to FIGS. 1A, 2A, 2E, 2G, 2H, and 2I, an embodiment includes an arrangement wherein on the first side 1110 of the body 1100, adjacent ones of the plurality of linear elongated ribs 1200 are not monolithically connected to each other.

From the foregoing illustrations depicted in FIGS. 2A-2I, it will be appreciated that the various constructs of the body 1100 of the Dk polarizer 1000 may be extrudable along a single axis, may be moldable along a single axis, or may be both extrudable and moldable along a single axis. For example: the constructs of FIGS. 2A-2I are all extrudable along the Y-axis (into the page); and, the constructs of FIGS. 2A, 2B, 2D, 2E, 2F, 2G, 2H, and 2I, are all single-axis moldable along the Z-axis. FIGS. 2E and 2F are of particular significance regarding molding, as they depict the draft angle 1230 relative to a Y-Z plane that facilitates single-axis molding along the Z-axis. While an example draft angle 1230 is depicted in the embodiment of FIGS. 2E and 2F, it will be appreciated that such draft angle 1230 may be employed in other embodiments of the body 1100 disclosed herein.

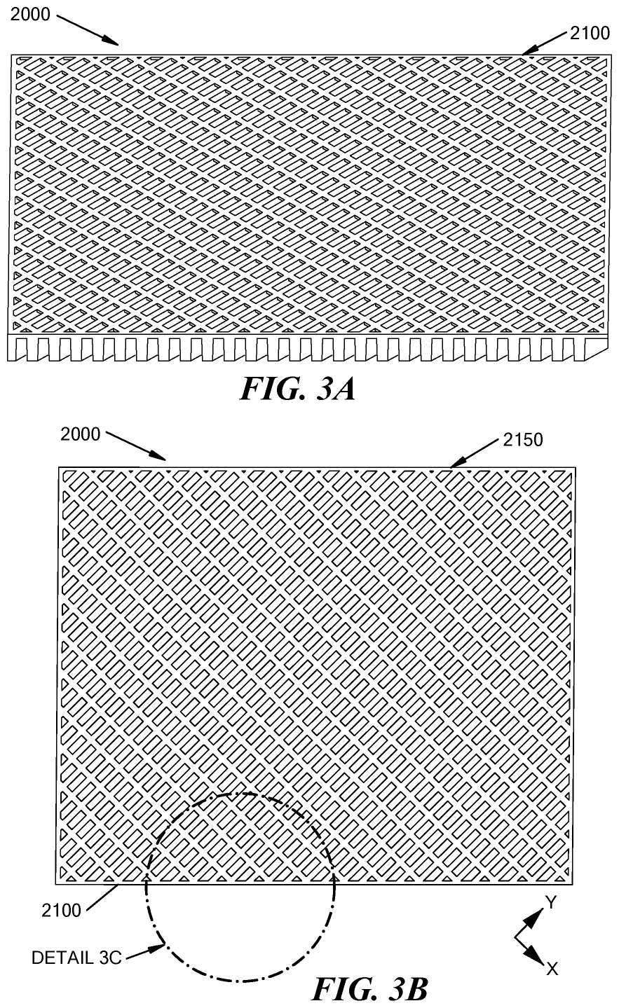

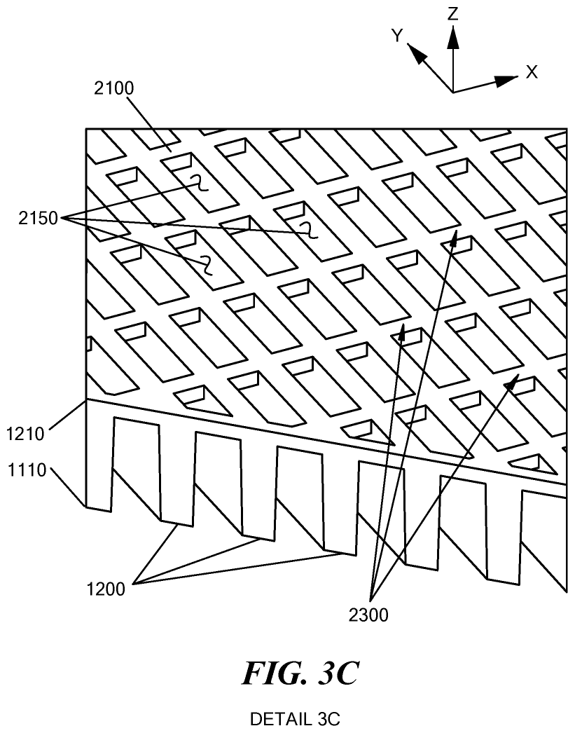

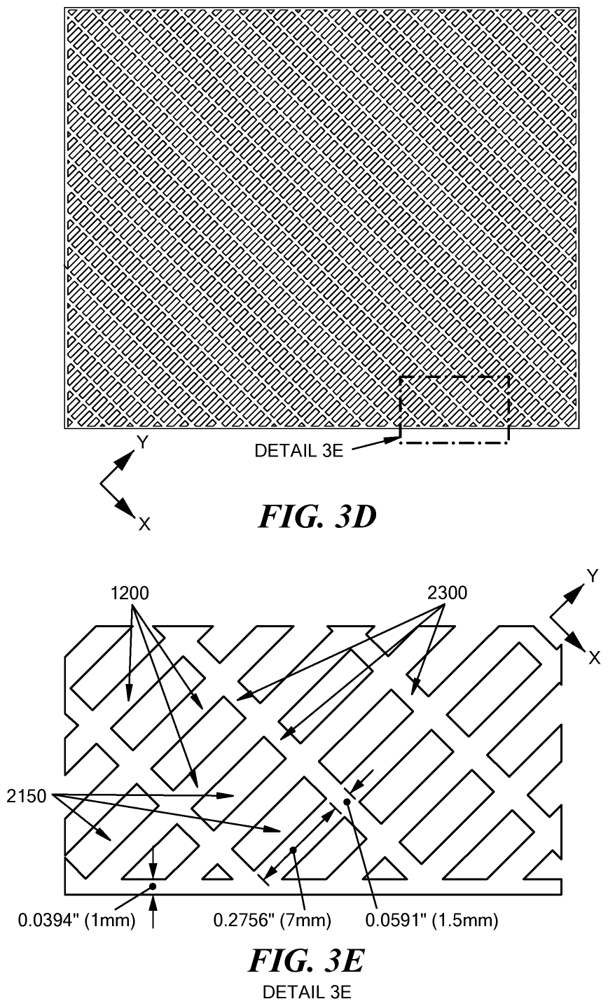

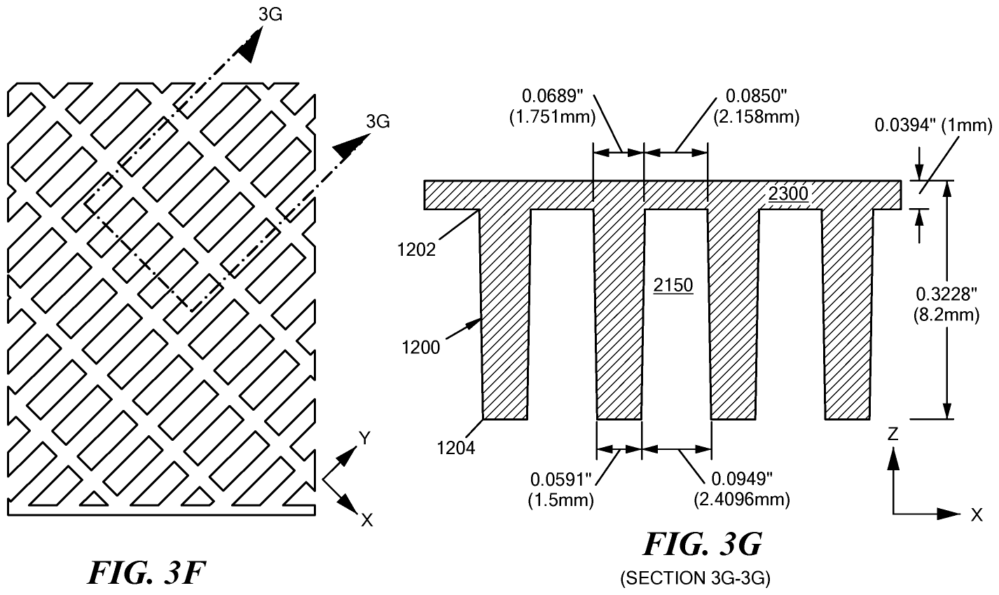

Reference is now made to FIGS. 3A-3G, which depict a second embodiment of a Dk polarizer 2000 having a monolithic body 2100 similar to the first Dk polarizer 1000 with monolithic body 1100, but instead of the plurality of connecting bridges forming a solid surface at the second side of the thickness, T, in the embodiments of FIGS. 3A-3G the second side 1120 of the body 2100 has a non-continuous, non-solid, planar form of connecting bridges 2300. In an embodiment, the plurality of connecting bridges 2300 are disposed between, and are uniformly spaced apart along a length of, adjacent ones of the plurality of linear elongated ribs 1200. As depicted, adjacent ones of the plurality of connecting bridges 2300 in combination with adjacent ones of the plurality of linear elongated ribs 1200, form voids 2150 through the monolithic body 2100 in the Z-direction. In an embodiment, the plurality of connecting bridges 2300 are uniformly spaced apart with respect to each other. In an embodiment, the plurality of connecting bridges 2300 form a plurality of linear connecting bridges 2300 that are monolithically connected to each other and to the plurality of linear elongated ribs 1200. In an embodiment, the plurality of linear connecting bridges 2300 are configured and arranged to be perpendicular to the plurality of linear elongated ribs 1200 as observed in the X-Y plane of the monolithic body 2100.

In an embodiment, the monolithic body 2100 has a Dk constant equal to or greater than 6 and equal to or less than 9. In an embodiment, the monolithic body 2100 is operational at an EM frequency of equal to or greater than 10 GHz equal to or less than 15 GHz.

In a particular example embodiment, and with reference to FIGS. 3D-3G, the monolithic body 2100 has a Dk constant equal to or greater than 7 and equal to or less than 8, a Y-direction spacing between adjacent linear elongated ribs 1200 of about 7 mm (as seen in the plan view of FIG. 3E), an X-direction width of adjacent linear connecting bridges 2300 of about 1.5 mm (as seen in the plan view of FIG. 3E), a Z-direction thickness of adjacent linear connecting bridges 2300 of about 1 mm (as seen in the cross section side view of FIG. 3G), an X-direction spacing at a proximal end 1202 (proximate the linear connecting bridges 2300) of and between adjacent linear elongated ribs 1200 of about 2.158 mm (as seen in the cross section side view of FIG. 3G), an X-direction thickness, at the proximal end 1202, of the linear elongated ribs 1200 of about 1.751 mm (as seen in the cross section side view of FIG. 3G), an X-direction spacing at distal end 1204 (opposite the proximal end 1202) of and between adjacent linear elongate ribs 1200 of about 2.4096 mm (as seen in the cross section side view of FIG. 3G), and an X-direction thickness, at the distal end 1204, of the linear elongated ribs 1200 of about 1.5 mm (as seen in the cross section side view of FIG. 3G). As can be seen from at least FIG. 3G, the linear elongated ribs 1200 have a molding draft angle along the Z-axis of about 1-degree. In the particular embodiment of FIGS. 3D-3G, the monolithic body 2100 is operational at an EM frequency of equal to or greater than 10 GHz and equal to or less than 15 GHz. In an embodiment, the above noted dimensions and operational frequencies for the particular embodiment of FIGS. 3D-3G may be scaled by f0/f for other frequency ranges, where f0 is 12.5 GHz and f is another frequency of interest.

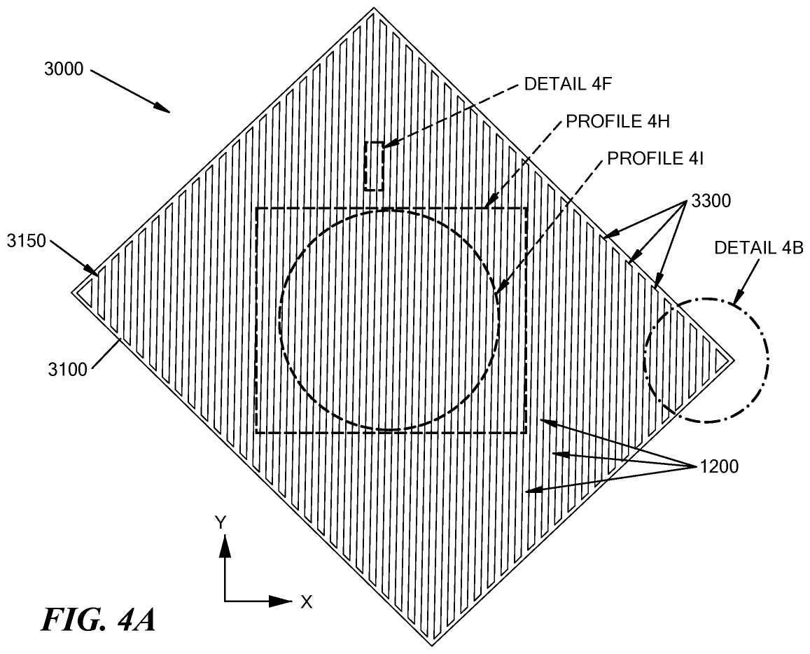

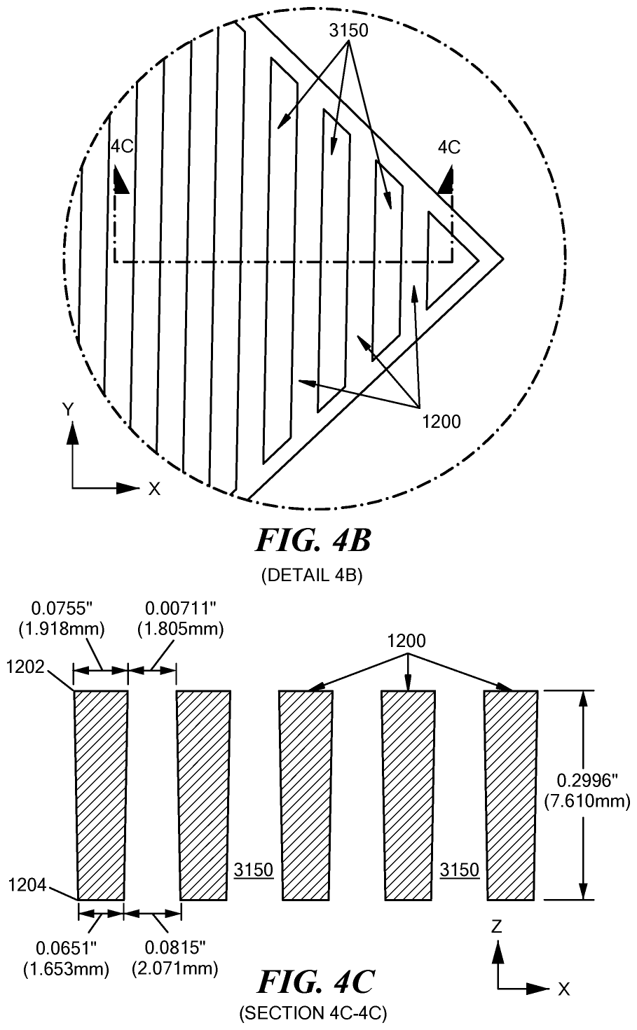

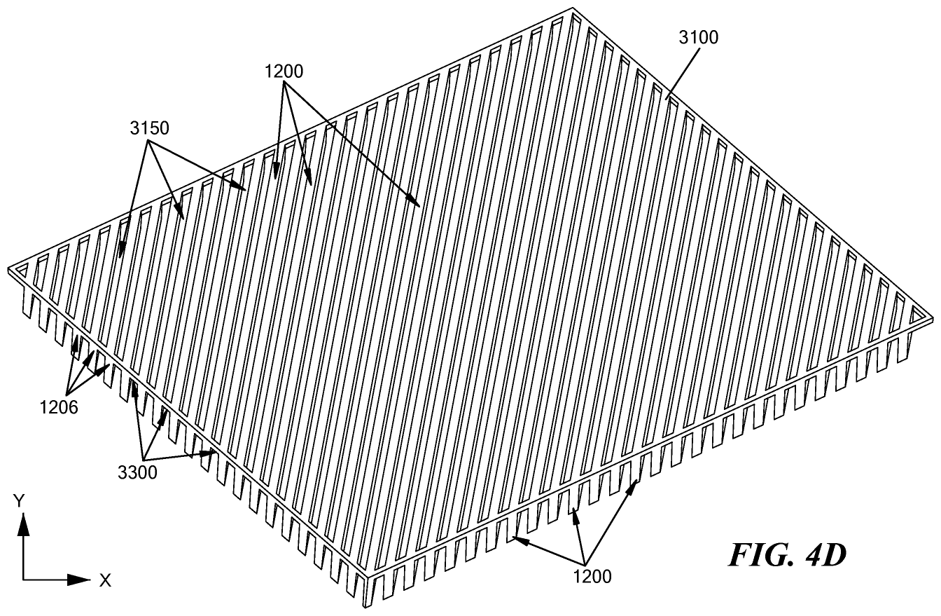

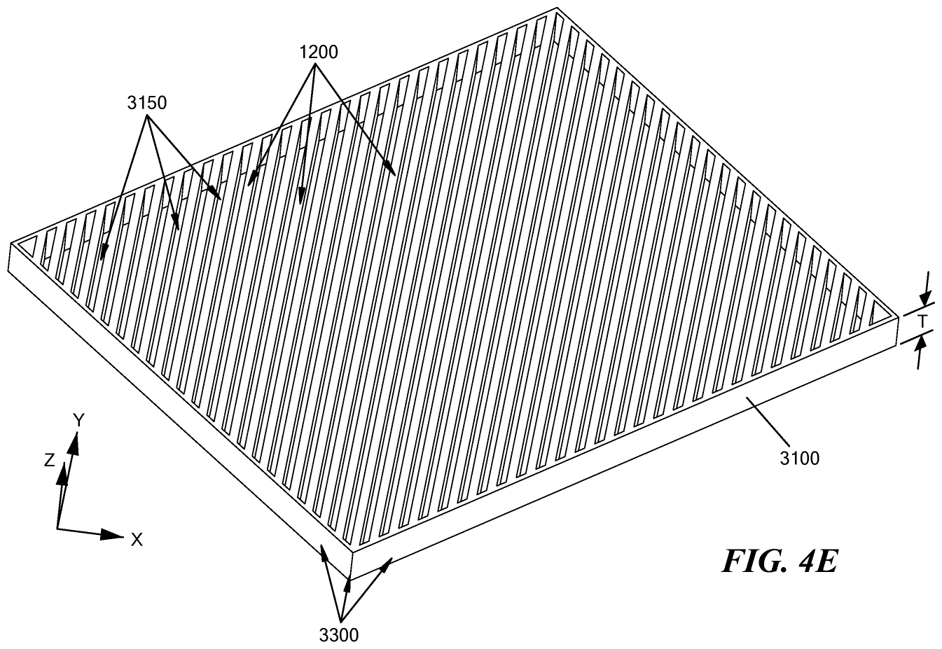

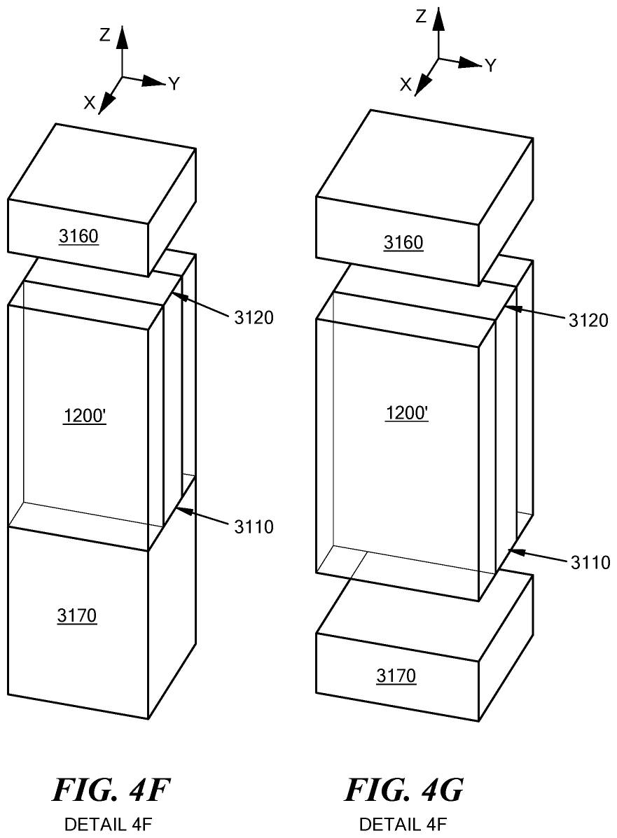

Reference is now made to FIGS. 4A-4E, which depict a third embodiment of a Dk polarizer 3000 having a monolithic body 3100 similar to the second Dk polarizer 2000 with monolithic body 2100, but instead of the plurality of connecting bridges being disposed between and uniformly spaced apart along a length of adjacent ones of the plurality of linear elongated ribs, the plurality of connecting bridges 3300 of the Dk polarizer 3000 are disposed at an outer perimeter of and formed monolithically with the ends of the plurality of linear elongated ribs 1200. Here, the plurality of connecting bridges 3300 are linear connecting bridges 3300 that form a picture frame around the outer perimeter of the linear elongated ribs 1200, where the plurality of linear connecting bridges are monolithically formed with opposing ends of adjacent ones of the plurality of linear elongated ribs 1200. As depicted, adjacent ones of the plurality of connecting bridges 3300 in combination with adjacent ones of the plurality of linear elongated ribs 1200, form voids 3150 through the monolithic body 3100 in the Z-direction.

In a particular example embodiment, and with reference to FIGS. 4A-4C, the monolithic body 3100 has a Dk constant equal to or greater than 7 and equal to or less than 8, an X-direction spacing at an upper end 1202 of and between adjacent linear elongated ribs 1200 of about 1.805 mm (as seen in the cross section side view of FIG. 4C), an X-direction thickness, at the end 1202, of the linear elongated ribs 1200 of about 1.918 mm (as seen in the cross section side view of FIG. 4C), an X-direction spacing at a lower end 1204 (opposite the upper end 1202) of and between adjacent linear elongate ribs 1200 of about 2.071 mm (as seen in the cross section side view of FIG. 4C), and an X-direction thickness, at the lower end 1204, of the linear elongated ribs 1200 of about 1.653 mm (as seen in the cross section side view of FIG. 4C. As can be seen from at least FIG. 4C, the linear elongated ribs 1200 have a molding draft angle along the Z-axis of about 1-degree. In the particular embodiment of FIGS. 4A-4C, the monolithic body 3100 is operational at an EM frequency of equal to or greater than 10 GHz and equal to or less than 15 GHz. In an embodiment, the above noted dimensions and operational frequencies for the particular embodiment of FIGS. 4A-4C may be scaled by f0/f for other frequency ranges, where f0 is 12.5 GHz and f is another frequency of interest.

Reference is now made to FIGS. 4D and 4E in combination with FIGS. 4A-4C, which depict alternate rotated isometric views of the monolithic body 3100 of FIG. 4A that specifically illustrates the monolithic connectivity between the plurality of linear elongated ribs 1200 and the plurality of connecting bridges 3300.

As depicted in FIG. 4D, each end 1206 of the plurality of linear elongated ribs 1200 is at least partially close-ended, in that each respective end 1206 of the plurality of linear elongated ribs 1200 is monolithically connected to a corresponding end 1206 of an adjacent one of the plurality of linear elongated ribs 1200 via a corresponding one of the plurality of connecting bridges 3300. In an embodiment, the plurality of connecting bridges 3300 form a frame, generally herein referred to as a picture frame, at an outer periphery of the monolithic body 3100, and are monolithically connected to respective ends 1206 of adjacent ones of the plurality of linear elongated ribs 1200.

As depicted in FIG. 4E, an embodiment includes an arrangement where each one of the plurality of connecting bridges 3300 has a height in the Z-direction that is equal to the overall thickness, T, of the monolithic body 3100.

In an embodiment, and as depicted in both FIGS. 4D and 4E, the plurality of connecting bridges 3300 and adjacent ones of the plurality of linear elongated ribs 1200 form voids 3150 through the monolithic body 3100 in the Z-direction. In the embodiments of FIGS. 4A-4E, the voids 3150 are present between adjacent ones of the plurality of linear elongated ribs 1200, and run the length of the associated adjacent ribs 1200. Further in the embodiment of FIGS. 4A-4E, the monolithic body 3100 has a Dk constant equal to or greater than 6 and equal to or less than 9, and is operational at an EM frequency of equal to or greater than 10 GHz and equal to or less than 15 GHz.

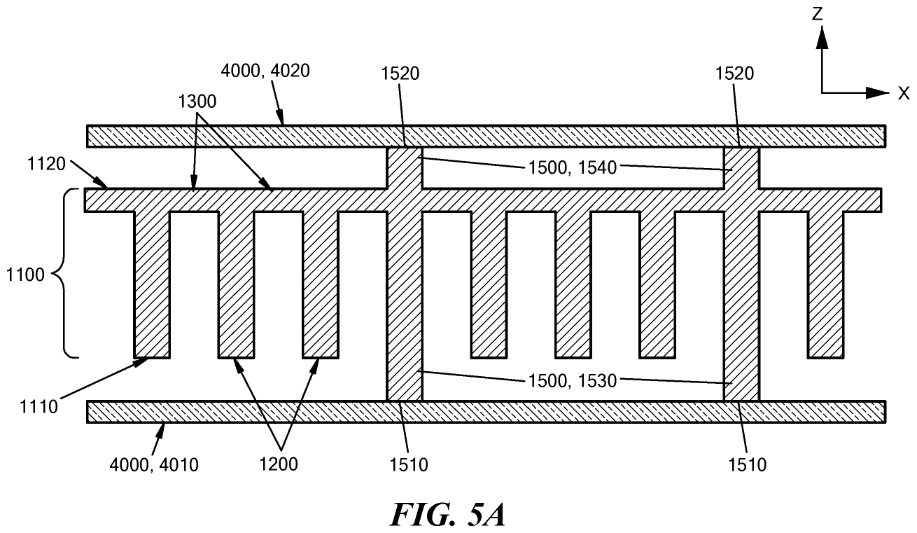

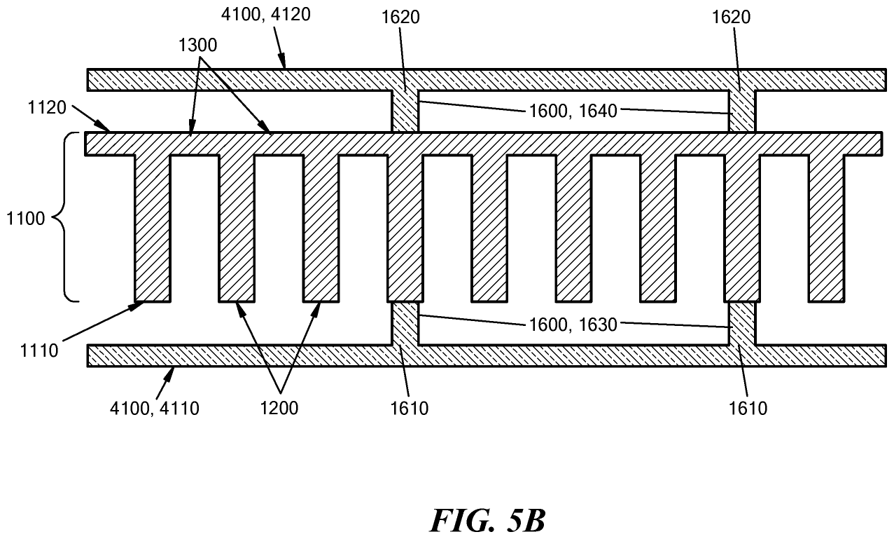

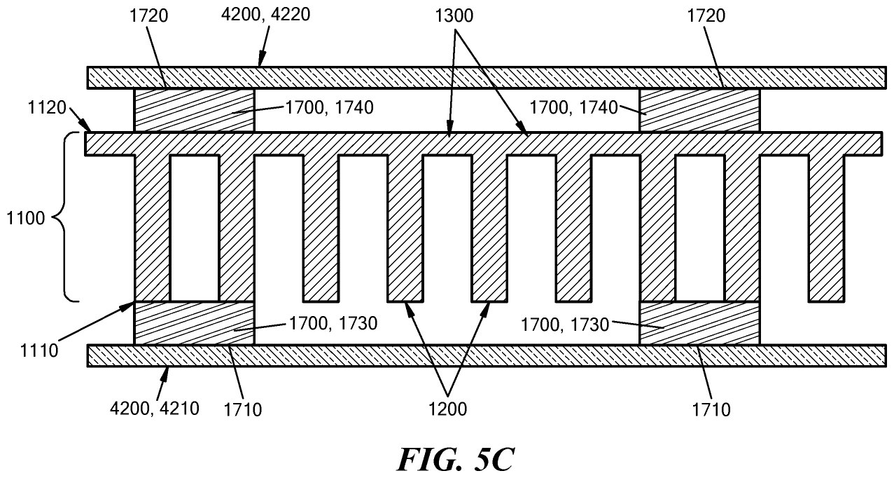

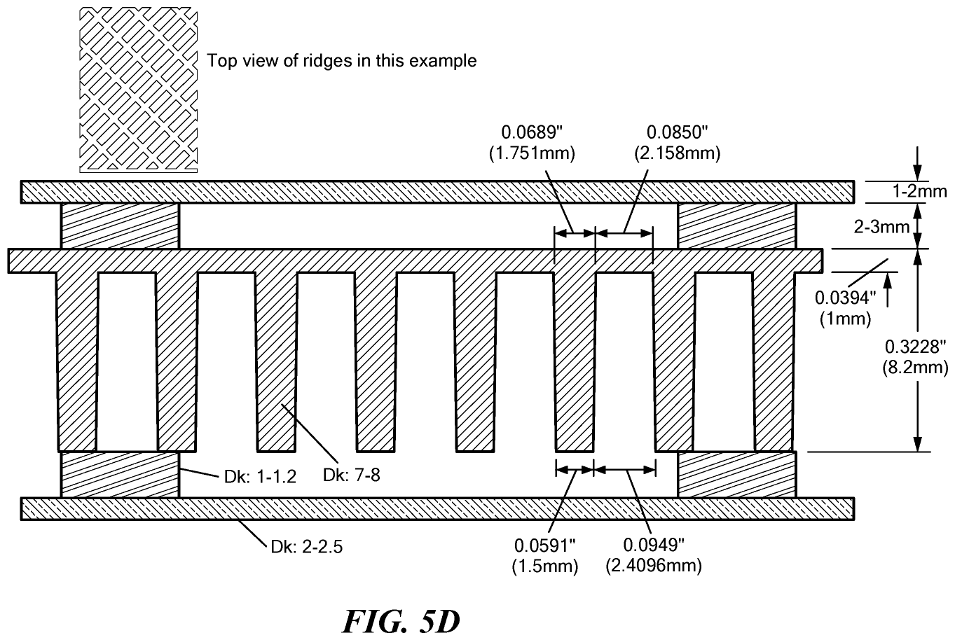

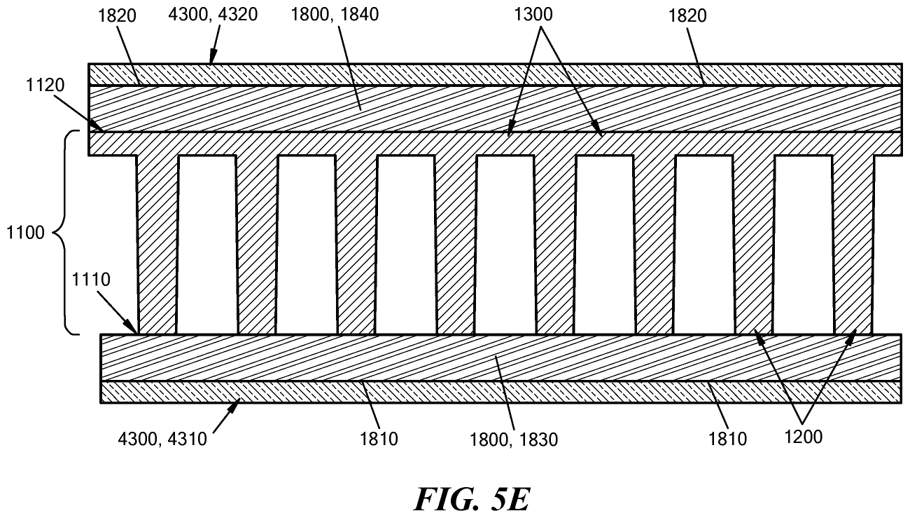

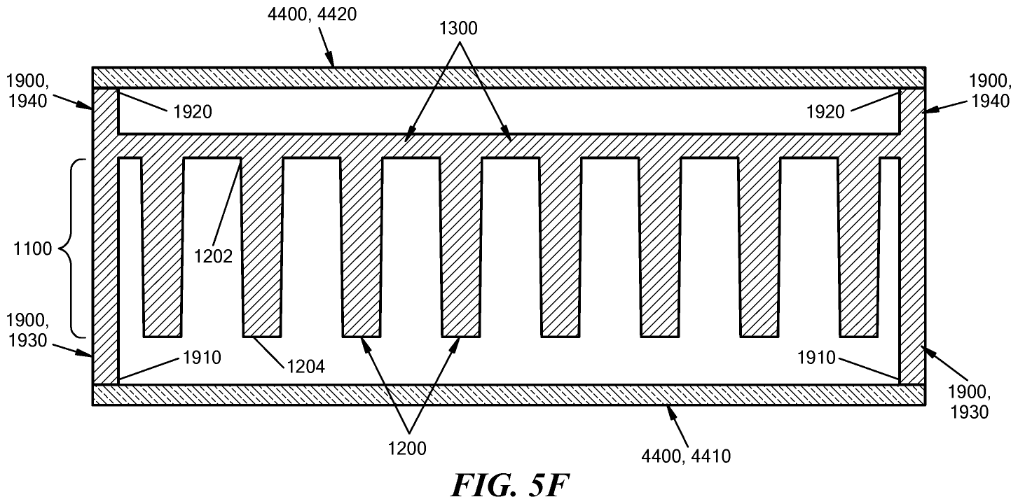

Reference is now made to FIGS. 4F and 4G, which depict alternative embodiments of Detail-4F depicted in FIG. 4A, where each of FIGS. 4F and 4G depict a portion 1200′ of one of the plurality of linear elongated ribs 1200 having a low Dk cover 3160 disposed over and spaced apart from the upper end 3120 of the portion 1200′, and a low Dk base 3170 disposed under the lower end 3110 of the portion 1200′. In FIG. 4F, the low Dk base 3170 is disposed in contact with the lower end 3110 of the portion 1200′, while in FIG. 4G, the low Dk base 3170 is spaced apart from the lower end 3110 of the portion 1200′. And while both FIGS. 4F and 4G depict the low Dk cover 3160 spaced apart from the upper end 3120 of the portion 1200′, it will be appreciated that another embodiment may have the low Dk cover 3160 disposed in contact with the upper end 3120 of the portion 1200′. In an embodiment, the low Dk cover 3160 and the low Dk base 3170 provide EM antireflection features 4000 in the form of layers (see FIG. 2I for example), which will now be discussed with reference to FIGS. 5A-5F, where each of FIGS. 5A-5F depict a monolithic body 1100 similar, if not identical, to that of FIG. 2A. However, it will be appreciated that other monolithic bodies as disclosed herein may be substituted for the monolithic body 1100 without detracting from a scope of an invention disclosed herein.

FIG. 5A depicts a monolithic body 1100 having at least one plurality of Dk spacers 1500 monolithically connected to and disposed: on the bottom 1110 of more than one of the plurality of linear elongated ribs 1200; on the top 1120 of the plurality of connecting bridges 1300 and disposed vertically over, in the Z-direction, more than one of the plurality of linear elongated ribs 1200; or, on the bottom 1110 of more than one of the plurality of linear elongated ribs 1200, and on the top 1120 of the plurality of connecting bridges 1300 and disposed vertically over, in the Z-direction, more than one of the plurality of linear elongated ribs 1200; and, at least one EM anti-reflection layer 4000 connected to the at least one plurality of Dk spacers 1500. In an embodiment, the at least one plurality of Dk spacers 1500 includes a first plurality of Dk spacers 1530 monolithically connected to and disposed on the bottom 1110 of more than one of the plurality of linear elongated ribs 1200; and, the at least one EM anti-reflection layer 4000 includes a lower EM anti-reflection layer 4010 connected to and disposed on the bottom 1510 of the first plurality of Dk spacers 1530. In an embodiment, the lower EM anti-reflection layer 4010 covers an entire outside X-Y area of the monolithic body 1100 as viewed from a plan view of the monolithic body 1100. In an embodiment, the lower EM anti-reflection layer 4010 includes a Dk material having a Dk constant that is less than the Dk constant of the Dk material of the monolithic body 1100. In an embodiment, the at least one plurality of Dk spacers 1500 includes a second plurality of Dk spacers 1540 monolithically connected to and disposed on top 1120 of the plurality of connecting bridges 1300 and disposed vertically over, in the Z-direction, more than one of the plurality of linear elongated ribs 1200; and, the at least one EM anti-reflection layer 4000 includes an upper EM anti-reflection layer 4020 connected to and disposed on the top 1520 of the second plurality of Dk spacers 1540. In an embodiment, the upper EM anti-reflection layer 4020 covers an entire outside X-Y area of the monolithic body 1100 as viewed from a plan view of the monolithic body 1100. In an embodiment, the upper EM anti-reflection layer 4020 includes a Dk material having a Dk constant that is less than the Dk constant of the Dk material of the monolithic body 1100.

FIG. 5B depicts a monolithic body 1100 having at least one plurality of Dk spacers 1600 connected to and disposed: on the bottom 1110 of more than one of the plurality of linear elongated ribs 1200; on the top 1120 of the plurality of connecting bridges 1300 and disposed vertically over, in the Z-direction, more than one of the plurality of linear elongated ribs 1200; or, on the bottom 1110 of more than one of the plurality of linear elongated ribs 1200, and on the top 1120 of the plurality of connecting bridges 1300 and disposed vertically over, in the Z-direction, more than one of the plurality of linear elongated ribs 1200; and, at least one EM anti-reflection layer 4100 monolithically connected to the at least one plurality of Dk spacers 1600. In an embodiment, the at least one plurality of Dk spacers 1600 includes a third plurality of Dk spacers 1630 connected to and disposed on the bottom 1110 of more than one of the plurality of linear elongated ribs 1200; and, the at least one EM anti-reflection layer 4100 includes a lower EM anti-reflection layer 4110 monolithically connected to and disposed on the bottom 1610 of the third plurality of Dk spacers 1630. In an embodiment, the lower EM anti-reflection layer 4110 covers an entire outside X-Y area of the monolithic body 1100 as viewed from a plan view of the monolithic body 1100. In an embodiment, the lower EM anti-reflection layer 4110 comprises a Dk material having a Dk constant that is less than the Dk constant of the Dk material of the monolithic body 1100. In an embodiment, the at least one plurality of Dk spacers 1600 includes a fourth plurality of Dk spacers 1640 connected to and disposed on top 1120 of the plurality of connecting bridges 1300 and disposed vertically over, in the Z-direction, more than one of the plurality of linear elongated ribs 1200; and, the at least one EM anti-reflection layer 4100 includes an upper EM anti-reflection layer 4120 monolithically connected to and disposed on the top 1620 of the fourth plurality of Dk spacers 1640. In an embodiment, the upper EM anti-reflection layer 4120 covers an entire outside X-Y area of the monolithic body 1100 as viewed from a plan view of the monolithic body 1100. In an embodiment, the upper EM anti-reflection layer 4120 includes a Dk material having a Dk constant that is less than the Dk constant of the Dk material of the monolithic body 1100.

FIG. 5C depicts a monolithic body 1100 having at least one plurality of Dk spacers 1700 connected to and disposed: on the bottom 1110 of more than one of the plurality of linear elongated ribs 1200, wherein each Dk spacer of the at least one plurality of Dk spacers 1700 bridges across at least two adjacent ones of the plurality of linear elongated ribs 1200; on the top 1120 of the plurality of connecting bridges 1300 and disposed vertically over, in the Z-direction, more than one of the plurality of linear elongated ribs 1200; or, on the bottom 1110 of more than one of the plurality of linear elongated ribs 1200, wherein each Dk spacer of the at least one plurality of Dk spacers 1700 bridges across at least two adjacent ones of the plurality of linear elongated ribs 1200, and on the top 1120 of the plurality of connecting bridges 1300 and disposed vertically over, in the Z-direction, more than one of the plurality of linear elongated ribs 1200; and, at least one EM anti-reflection layer 4200 connected to the at least one plurality of Dk spacers 1700. In an embodiment, the at least one plurality of Dk spacers 1700 includes a fifth plurality of Dk spacers 1730 connected to and disposed on the bottom 1110 of more than one of the plurality of linear elongated ribs 1200, wherein each one of the fifth plurality of Dk spacers 1730 includes foam; and, the at least one EM anti-reflection layer 4200 includes a lower EM anti-reflection layer 4210 connected to and disposed on the bottom 1710 of the fifth plurality of Dk spacers 1730. In an embodiment, each one of the fifth plurality of Dk spacers 1730 bridges across at least two adjacent ones of the plurality of linear elongated ribs 1200. In an embodiment, the lower EM anti-reflection layer 4210 covers an entire outside X-Y area of the monolithic body 1100 as viewed from a plan view of the monolithic body 1100. In an embodiment, the lower EM anti-reflection layer 4210 includes a Dk material having a Dk constant that is less than the Dk constant of the Dk material of the monolithic body 1100. In an embodiment, the at least one plurality of Dk spacers 1700 includes a sixth plurality of Dk spacers 1740 connected to and disposed on the top 1120 of the plurality of connecting bridges 1300 and disposed vertically over, in the Z-direction, more than one of the plurality of linear elongated ribs 1200; and, the at least one EM anti-reflection layer 4200 includes an upper EM anti-reflection layer 4220 connected to and disposed on the top 1720 of the sixth plurality of Dk spacers 1740. In an embodiment, each one of the sixth plurality of Dk spacers 1740 bridges across at least two adjacent ones of the plurality of linear elongated ribs 1200. In an embodiment, the sixth plurality of Dk spacers 1740 includes foam. In an embodiment, the upper EM anti-reflection layer 4220 covers an entire outside X-Y area of the monolithic body 1100 as viewed from a plan view of the monolithic body 1100. In an embodiment, the upper EM anti-reflection layer 4220 includes a Dk material having a Dk constant that is less than the Dk constant of the Dk material of the monolithic body 1100.

FIG. 5D depicts the identical construct as that depicted in FIG. 5C, but with example dimensions and material properties illustrated. For example: the plurality of linear elongated ribs 1200 have a Dk value equal to or greater than 7 and equal to or less than 8; the at least one plurality of Dk spacers 1700 have a Dk value greater than 1 and equal to or less than 1.2; the at least one EM anti-reflection layer 4200 has a Dk value equal to or greater than 2 and equal to or less than 2.5; the monolithic body 1100 has a thickness T equal to about 8.2 mm; the plurality of connecting bridges 1300 have a thickness equal to about 1 mm; the at least one plurality of Dk spacer 1700 have a thickness equal to or greater than about 2 mm and equal to or less than about 3 mm; the at least one EM anti-reflection layer 4200 has a thickness equal to or greater than 1 mm and equal to or less than 2 mm; adjacent ones of the plurality of linear elongated ribs 1200 have a spacing at the proximal end of about 2.158 mm, and a spacing at the distal end of about 2.4096 mm; and, the plurality of linear elongated ribs 1200 have a width at the proximal end of about 1.751 mm, and a width at the distal end of about 1.5 mm.

FIG. 5E depicts a monolithic body 1100 having at least one Dk spacer layer 1800 connected to and disposed: on the bottom 1110 of the more than one plurality of linear elongated ribs 1200, and bridging across multiple adjacent ones of the plurality of linear elongated ribs 1200; on the top 1120 of the plurality of connecting bridges 1300, and bridging across multiple adjacent ones of the plurality of linear elongated ribs 1200; or, on the bottom 1110 of the more than one plurality of linear elongated ribs 1200, and bridging across multiple adjacent ones of the plurality of linear elongated ribs 1200, and on the top 1120 of the plurality of connecting bridges 1300, and bridging across multiple adjacent ones of the plurality of linear elongated ribs 1200; and at least one EM anti-reflection layer 4300 connected to and disposed on the at least one Dk spacer 1800. In an embodiment, the at least one Dk spacer layer 1800 includes a first Dk spacer layer 1830 connected to and disposed on the bottom 1110 of the more than one plurality of linear elongated ribs 1200, the first Dk spacer layer 1830 bridging across multiple adjacent ones of the plurality of linear elongated ribs 1200; and, the at least one EM anti-reflection layer 4300 includes a lower EM anti-reflection layer 4310 connected to and disposed on the bottom 1810 of the first Dk spacer layer 1830. In an embodiment, the first Dk spacer layer 1830 includes foam. In an embodiment, the first Dk spacer layer 1830 and the lower EM anti-reflection layer 4310 each cover an entire outside X-Y area of the monolithic body 1100 as viewed from a plan view of the monolithic body 1100. In an embodiment, the lower EM anti-reflection layer 4310 includes a Dk material having a Dk constant that is less than the Dk constant of the Dk material of the monolithic body 1100. In an embodiment, the at least one Dk spacer layer 1800 includes a second Dk spacer layer 1840 connected to and disposed on the top 1120 of the plurality of connecting bridges 1300, the second Dk spacer layer 1840 bridging across multiple adjacent ones of the plurality of linear elongated ribs 1200; and, the at least one EM anti-reflection layer 4300 includes an upper EM anti-reflection layer 4320 connected to and disposed on the top 1820 of the second Dk spacer layer 1840. In an embodiment, the second Dk spacer layer 1840 includes foam. In an embodiment, the second Dk spacer layer 1840 and the upper EM anti-reflection layer 4320 each cover an entire outside X-Y area of the monolithic body 1100 as viewed from a plan view of the monolithic body 1100. In an embodiment, the upper EM anti-reflector layer 4320 includes a Dk material having a Dk constant that is less than the Dk constant of the Dk material of the monolithic body 1100.

FIG. 5F depicts a monolithic body 1100 having at least one Dk support frame 1900 disposed around an outer perimeter 1150 (best seen with reference to FIG. 1A) of the monolithic body 1100 and being monolithically formed with the plurality of connecting bridges 1300, the at least one Dk support frame 1900: extending down below a distal end 1204 of the plurality of linear elongated ribs 1200; extending above the plurality of connecting bridges 1300; or, extending down below a distal end 1204 of the plurality of linear elongated ribs 1200, and extending above the plurality of connecting bridges 1300; and, at least one EM anti-reflection 4400 connected to the at least one Dk support frame 1900. In an embodiment, the at least one Dk support frame 1900 includes a first Dk support frame 1930 disposed around the outer perimeter 1150 of the monolithic body 1100 and being monolithically formed with the plurality of connecting bridges 1300, the first Dk support frame 1930 extending down below a distal end 1204 of the plurality of linear elongated ribs 1200; and, the at least one EM anti-reflection layer 4400 includes a lower EM anti-reflection layer 4410 connected to and disposed on the bottom 1910 of the first Dk support frame 1930. In an embodiment, the lower EM anti-reflection layer 4410 covers an entire outside X-Y area of the monolithic body 1100 as viewed from a plan view of the monolithic body 1100. In an embodiment, the lower EM anti-reflector layer 4410 includes a Dk material having a Dk constant that is less than the Dk constant of the Dk material of the monolithic body 1100. In an embodiment, the at least one Dk support frame 1900 includes a second Dk support frame 1940 disposed around the outer perimeter 1150 of the monolithic body 1100 and being monolithically formed with the plurality of connecting bridges 1300, the second Dk support frame 1940 extending above the plurality of connecting bridges 1300; and, the at least one EM anti-reflection layer 4400 includes an upper EM anti-reflection layer 4420 connected to and disposed on the top 1920 of the second Dk support frame 1940. In an embodiment, the upper EM anti-reflection layer 4420 covers an entire outside X-Y area of the monolithic body 1100 as viewed from a plan view of the monolithic body 1100. In an embodiment, the upper EM anti-reflector layer 4420 includes a Dk material having a Dk constant that is less than the Dk constant of the Dk material of the monolithic body 1100.

With reference to all of the foregoing, an embodiment includes an arrangement wherein the monolithic body 1100, 2100, 3100 is formed completely of a Dk material. In an embodiment, the monolithic body 1100, 2100, 3100 has a rectangular outer profile (see for example 1150, 2150, 3150, in FIGS. 1A, 3B, 4A) as observed in the X-Y plane of the monolithic body 1100, 2100, 3100, and as depicted in at least FIGS. 1A, 3B, and 4A. In an embodiment, the plurality of linear elongated ribs 1200 extend diagonally across the rectangular outer profile 1150, 2150, 3150, and as depicted extend across the rectangular outer profile 1150, 2150, 3150 at an angle of 45-degrees relative to a side edge of the rectangular outer profile 1150, 2150, 3150. In an embodiment, the plurality of linear elongated ribs 1200 extend parallel to a side edge of the rectangular outer profile (see Profile-4H in FIG. 4A for example). In an embodiment, the plurality of linear elongated ribs 1200 do not extend parallel to a side edge of the rectangular outer profile (see FIG. 4A, and Profile-4I in FIG. 4A, for example). In an embodiment, the monolithic body 1100 has a non-rectangular outer profile (a circular outer profile for example) as observed in the X-Y plane of the monolithic body 1100, 2100, 3100 (see Profile-4I in FIG. 4A for example).

With reference to, and in consideration of, all of the foregoing descriptions of the various embodiments disclosed herein, an embodiment includes an arrangement wherein a distance in the X-direction from the center of one of the plurality of linear elongated ribs 1200 to the center of an adjacent one of the plurality of linear elongated ribs 1200 defines a unit cell dimension, wherein the unit cell dimension is equal to or less than λ/2, where λ is an associated wavelength at a defined frequency. In an embodiment, at least the plurality of linear elongated ribs 1200 and the plurality of connecting bridges 1300 are features of the monolithic body 1100, 2100, 3100 that are structurally configured to be producible by a single-axis mold that closes and opens along the Z-direction. In an embodiment, each rib of the plurality of linear elongated ribs 1200 has a draft angle that drafts inward from the second side (proximal end) to the first side (distal end) of the thickness T of the monolithic body 1100, 2100, 3100. In an embodiment, the draft angle is equal to or greater than 0.5-degrees and equal to or less than 5-degrees.

From the foregoing description of structure, it will be appreciated that an embodiment disclosed herein also includes a method of making any one of the foregoing Dk polarizers 1000, 2000, 3000 by molding the corresponding monolithic body 1100, 2100, 3100 via a single-axis mold that closes and opens along the Z-direction, or by extruding particular ones of the corresponding monolithic body 1100, 3100 along the Y-axis. For example, the monolithic body 1100 of the first Dk polarizer 1000 is capable of being extruded along the Y-axis of an orthogonal X-Y-Z coordinate system (absent the push pins 1130), and single-axis molded along the Z-axis; the monolithic body 2100 of the second Dk polarizer 2000 is capable of being single-axis molded along the Z-axis, but not extruded; and, the monolithic body 3100 of the third Dk polarizer 3000 is capable of being extruded along the Z-axis (where a full picture frame is employed), and single-axis molded along the Z-axis (with a full or a partial picture frame).

As noted herein above with reference to the monolithic body 1100 associated with at least FIG. 1C, each connecting bridge of the plurality of connecting bridges 1300 has an x-z cross section thickness T2 that is relatively thin in the Z-direction as compared to the x-z cross section height T1 of an associated linear elongated rib 1200 in the Z-direction. As such, an in view of the similarities between the various monolithic body constructs disclosed and described herein, it will be appreciated that a relatively thin design for the plurality of connecting bridges 1300 of the other monolithic bodies 2100, 3100 relative to the corresponding plurality of linear elongated ribs 1200 is inherently if not explicitly also disclosed herein. An advantage of employing relatively thin connecting bridges 1300 is to minimize any negative influence the connecting bridges 1300 may have on the transformation from linear to circular polarization, or vice versa, function of the associated Dk polarizer 1000, 2000, 3000.

An advantage that the third Dk polarizer 3000 may have over the first and second Dk polarizers 1000, 2000, particularly where the third Dk polarizer 3000 has a relatively thin, or otherwise minimally sized, plurality of connecting bridges 1300 that form the picture frame, is that a plurality of the third Dk polarizer 3000 may be adjacently arranged in an array for ease of manufacturing of a large scale Dk polarizer.

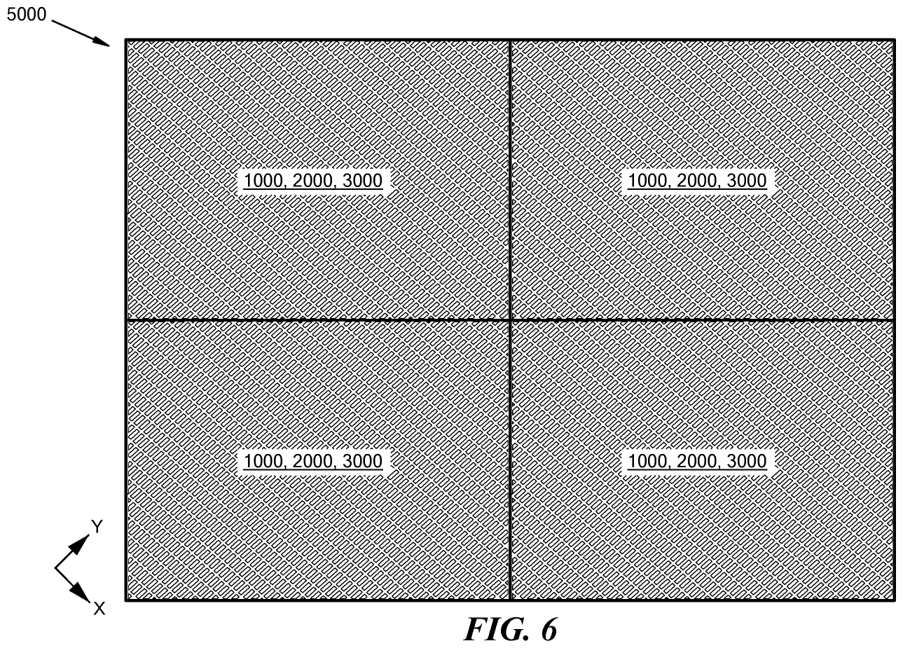

In an embodiment, and with reference now to FIG. 6, a plurality of any one of the foregoing Dk polarizers 1000, 2000, 3000, may be assembled side-by-side and in abutment with each other in a tiled arrangement to form a Dk polarizer assembly or array 5000. In an embodiment, the tiled arrangement is a planar arrangement and the array 5000 is a planar array. In an embodiment, the plurality of linear elongated ribs 1200 (see FIGS. 1A, 3A, 4A for example) of each of the plurality of Dk polarizers 1000, 2000, 3000 of the array 5000 are aligned in a same direction, such as along the Y-axis for example. In an embodiment, each monolithic body 1100, 2100, 3100 (see FIGS. 1A, 3A, 4A for example) of respective ones of the plurality of Dk polarizers 1000, 2000, 3000 of the array 5000 has its corresponding overall thickness dimension, T, aligned in the Z-direction.

As used herein, the term monolithic means a structure integrally formed from a single material composition. As used herein, the phrase integrally formed means a structure formed with material common to the rest of the structure absent material discontinuities from one region of the structure to another, such as a structure produced from a plastic molding process, a 3D printing process, a deposition process, or a machined or forged metal-working process, for example. Alternatively, integrally formed means a unitary one-piece indivisible structure.

As used herein, the phrase “about” or “equal to about” is intended to account for manufacturing tolerances and/or insubstantial deviations from a nominal value that do not detract from a purpose disclosed herein and fall within a scope of the appended claims.

While certain combinations of individual features have been described and illustrated herein, it will be appreciated that these certain combinations of features are for illustration purposes only and that any combination of any of such individual features may be employed in accordance with an embodiment, whether or not such combination is explicitly illustrated, and consistent with the disclosure herein. Any and all such combinations of features as disclosed herein are contemplated herein, are considered to be within the understanding of one skilled in the art when considering the application as a whole, and are considered to be within the scope of the invention disclosed herein, as long as they fall within the scope of the invention defined by the appended claims, in a manner that would be understood by one skilled in the art.

While an invention has been described herein with reference to example embodiments, it will be understood by those skilled in the art that various changes may be made and equivalents may be substituted for elements thereof without departing from the scope of the claims. Many modifications may be made to adapt a particular situation or material to the teachings of the invention without departing from the essential scope thereof. Therefore, it is intended that the invention not be limited to the particular embodiment or embodiments disclosed herein as the best or only mode contemplated for carrying out this invention, but that the invention will include all embodiments falling within the scope of the appended claims. In the drawings and the description, there have been disclosed example embodiments and, although specific terms and/or dimensions may have been employed, they are unless otherwise stated used in a generic, exemplary and/or descriptive sense only and not for purposes of limitation, the scope of the claims therefore not being so limited. The use of the terms first, second, etc. do not denote any order or importance, but rather the terms first, second, etc. are used to distinguish one element from another. The use of the terms a, an, etc. do not denote a limitation of quantity, but rather denote the presence of at least one of the referenced item. The term “comprising” as used herein does not exclude the possible inclusion of one or more additional features. And, any background information provided herein is provided to reveal information believed by the applicant to be of possible relevance to the invention disclosed herein. No admission is necessarily intended, nor should be construed, that any of such background information constitutes prior art against an embodiment of the invention disclosed herein.

In view of all of the foregoing, it will be appreciated that various aspects of an embodiment are disclosed herein, which are in accordance with, but not limited to, at least the following aspects and/or combinations of aspects.
Aspect 1. A dielectric, Dk, polarizer for electromagnetic, EM, applications, the Dk polarizer comprising: a monolithic body of Dk material comprising a plurality of linear elongated ribs that are disposed parallel with each other and that are uniformly spaced apart with respect to each other; wherein each rib of the plurality of linear elongated ribs has a cross section x-z profile relative to an orthogonal X-Y-Z coordinate system associated with the monolithic body; wherein the Y-direction of the coordinate system is oriented in a direction of elongation of the plurality of linear elongated ribs; wherein the Z-direction of the coordinate system is oriented in a direction of propagation of an EM wave, when present at the Dk polarizer, through the uniformly spaced apart plurality of linear elongated ribs; wherein the monolithic body has an overall thickness dimension, T, aligned in the Z-direction, that extends from a first side to a second side of the body, the second side being at dimension T relative to the first side; wherein adjacent ones of the plurality of linear elongated ribs are monolithically connected to each other by a plurality of connecting bridges; wherein the plurality of connecting bridges are disposed at a location equal to or greater than T/2 and equal to or less than T.
Aspect 2. The Dk polarizer of Aspect 1, wherein: the plurality of connecting bridges are disposed closer to the second side than to the first side.
Aspect 3. The Dk polarizer of Aspect 1, wherein: the plurality of connecting bridges are disposed at the second side.
Aspect 4. The Dk polarizer of Aspect 1, wherein: the plurality of connecting bridges comprise a first plurality of the connecting bridges disposed at or proximate to the first side of the body, and a second plurality of the connecting bridges disposed at or proximate to the second side of the body.
Aspect 5. The Dk polarizer of any one of Aspects 1 to 3, wherein: at least one of the plurality of linear elongated ribs comprises at least one region having an expanded x-z cross section in conjunction with an expanded x-y cross section relative to x-z and x-y cross sections of a non-expanded region of a corresponding linear elongated rib.
Aspect 6. The Dk polarizer of Aspect 5, wherein: the at least one region having an expanded x-z and x-y cross sections has a partial circular profile in the X-Y plane.
Aspect 7. The Dk polarizer of any one of Aspects 5 to 6, wherein: the Dk material of the at least one region having the expanded x-z and x-y cross sections extends the full height of the corresponding linear elongated rib.
Aspect 8. The Dk polarizer of any one of Aspects 1 to 3, wherein: on the first side of the thickness, T, adjacent ones of the plurality of linear elongated ribs are not monolithically connected to each other.
Aspect 9. The Dk polarizer of any one of Aspects 1 to 8, wherein: each connecting bridge of the plurality of connecting bridges has an x-z cross section that is relatively thin in the Z-direction as compared to the x-z cross section of an associated linear elongated rib in the Z-direction.
Aspect 10. The Dk polarizer of any one of Aspects 1 to 9, wherein: the plurality of connecting bridges are disposed between, and uniformly spaced apart along a length of, adjacent ones of the plurality of linear elongated ribs; and adjacent ones of the plurality of connecting bridges, and adjacent ones of the plurality of linear elongated ribs, form voids through the monolithic body in the Z-direction.
Aspect 11 The Dk polarizer of Aspect 10, wherein: the monolithic body has a Dk constant equal to or greater than 6 and equal to or less than 9.
Aspect 12. The Dk polarizer of Aspect 11, wherein: the monolithic body is operational at an EM frequency of 10 GHz to 15 GHz.
Aspect 13. The Dk polarizer of any one of Aspects 10 to 12, wherein: the plurality of connecting bridges form a plurality of linear connecting bridges that are monolithically connected to each other and to the plurality of linear elongated ribs.
Aspect 14. The Dk polarizer of Aspect 13, wherein: the plurality of linear connecting bridges are uniformly spaced apart with respect to each other.
Aspect 15. The Dk polarizer of any one to Aspects 13 to 14, wherein: the plurality of linear connecting bridges are configured and arranged to be perpendicular to the plurality of linear elongated ribs as observed in the X-Y plane of the monolithic body.
Aspect 16. The Dk polarizer of any one of Aspects 1 to 8, wherein: the plurality of connecting bridges form a solid surface at the second side of the thickness, T, the solid surface being absent of voids through the monolithic body in the Z-direction.
Aspect 17. The Dk polarizer of Aspect 16, wherein: the monolithic body has a Dk constant equal to or greater than 2 and equal to or less than 4.
Aspect 18. The Dk polarizer of Aspect 17, wherein: the monolithic body is operational at an EM frequency of 30 GHz to 100 GHz.
Aspect 19. The Dk polarizer of any one of Aspects 1 to 18, wherein: the monolithic body is formed completely of a Dk material.
Aspect 20. The Dk polarizer of any one of Aspects 1 to 19, wherein: the monolithic body has a rectangular outer profile as observed in the X-Y plane of the monolithic body.
Aspect 21. The Dk polarizer of Aspect 20, wherein: the plurality of linear elongated ribs extend diagonally across the rectangular outer profile.
Aspect 22. The Dk polarizer of Aspect 21, wherein: the plurality of linear elongated ribs extend across the rectangular outer profile at an angle of 45-degrees relative to a side edge of the rectangular outer profile.
Aspect 23. The Dk polarizer of Aspect 20, wherein: the plurality of linear elongated ribs extend parallel to a side edge of the rectangular outer profile.
Aspect 24. The Dk polarizer of Aspect 20, wherein: the plurality of linear elongated ribs do not extend parallel to a side edge of the rectangular outer profile.
Aspect 25. The Dk polarizer of any one of Aspects 1 to 19, wherein: the monolithic body has a non-rectangular outer profile as observed in the X-Y plane of the monolithic body.
Aspect 26. The Dk polarizer of Aspect 25, wherein: the monolithic body has a circular outer profile as observed in the X-Y plane of the monolithic body.
Aspect 27. The Dk polarizer of any one of Aspects 1 to 26, wherein: each end of the plurality of linear elongated ribs is open-ended, in that each respective end is not connected to a corresponding end of an adjacent one of the plurality of linear elongated ribs.
Aspect 28. The Dk polarizer of any one of Aspects 1 to 26, wherein: each end of the plurality of linear elongated ribs is at least partially close-ended, in that each respective end of the plurality of linear elongated ribs is monolithically connected to a corresponding end of an adjacent one of the plurality of linear elongated ribs.
Aspect 29. The Dk polarizer of Aspect 28, wherein: each respective end of the plurality of linear elongated ribs is monolithically connected to a corresponding end of an adjacent one of the plurality of linear elongated ribs via the plurality of connecting bridges.
Aspect 30. The Dk polarizer of any one of Aspect 1 to 6, wherein: the plurality of connecting bridges form a frame at an outer periphery of the monolithic body, and are monolithically connected to respective ends of adjacent ones of the plurality of linear elongated ribs.
Aspect 31. The Dk polarizer of Aspect 30, wherein: each one of the plurality of connecting bridges has a height in the Z-direction that is equal to the overall thickness, T, of the monolithic body.
Aspect 32. The Dk polarizer of Aspect 31, wherein: the plurality of connecting bridges, and adjacent ones of the plurality of linear elongated ribs, form voids through the monolithic body in the Z-direction.
Aspect 33. The Dk polarizer of Aspect 32, wherein: the voids are present between adjacent ones of the plurality of linear elongated ribs, and run the length of the associated adjacent ribs.
Aspect 34. The Dk polarizer of any one of Aspects 30 to 33, wherein: the monolithic body has a Dk constant equal to or greater than 6 and equal to or less than 9.
Aspect 35. The Dk polarizer of Aspect 34, wherein: the monolithic body is operational at an EM frequency of 10 GHz to 15 GHz.
Aspect 36. The Dk polarizer of any one of Aspects 1 to 29, further comprising: at least one plurality of EM anti-reflection features monolithically connected to and disposed: on the bottom of the plurality of linear elongated ribs; on the top of the plurality of linear elongated ribs; or, on both the bottom and the top of the plurality of linear elongated ribs.
Aspect 37. The Dk polarizer of Aspect 36, wherein: the at least one plurality of EM anti-reflection features comprises a first plurality of EM anti-reflection features monolithically connected to and disposed on the bottom of the plurality of linear elongated ribs.
Aspect 38. The Dk polarizer of Aspect 37, wherein: each EM anti-reflection feature of the first plurality of EM anti-reflection features comprises a projection having an x-z cross section that is smaller in both the x-direction and the z-direction than the x-z cross section of the corresponding linear elongated rib.
Aspect 39. The Dk polarizer of any one of Aspects 36 to 38, wherein: the at least one plurality of EM anti-reflection features comprises a second plurality of EM anti-reflection features are monolithically connected to and disposed on top of the plurality of connecting bridges and disposed vertically over, in the Z-direction, the plurality of linear elongated ribs.
Aspect 40. The Dk polarizer of Aspect 39, wherein: each EM anti-reflection feature of the second plurality of EM anti-reflection features comprises a projection having an x-z cross section that is smaller in the z-direction than that of the x-z-cross section of the corresponding linear elongated rib, and wherein adjacent ones of the second plurality of EM anti-reflection features do not directly touch each other.
Aspect 41. The Dk polarizer of any one of Aspects 1 to 29, further comprising: at least one EM anti-reflection layer connected to and disposed: on the bottom of the plurality of linear elongated ribs; on the top of the plurality of linear elongated ribs; or, on both the bottom and the top of the plurality of linear elongated ribs.
Aspect 42. The Dk polarizer of Aspect 41, wherein: the at least one EM anti-reflection layer comprises a first EM anti-reflection layer connected to and disposed on the bottom of the plurality of linear elongated ribs.
Aspect 43. The Dk polarizer of Aspect 42, wherein: the first EM anti-reflection layer covers an entire outside X-Y area of the monolithic body as viewed from a plan view of the monolithic body.
Aspect 44. The Dk polarizer of any one of Aspects 42 to 43, wherein: the first EM anti-reflection layer comprises a Dk material having a Dk constant that is less than the Dk constant of the Dk material of the monolithic body.
Aspect 45. The Dk polarizer of any one of Aspects 41 to 44, wherein: the at least one EM anti-reflection layer comprises a second EM anti-reflection layer connected to and disposed on top of the plurality of connecting bridges.
Aspect 46. The Dk polarizer of Aspect 45, wherein: the second EM anti-reflection layer covers an entire outside X-Y area of the monolithic body as viewed from a plan view of the monolithic body.
Aspect 47. The Dk polarizer of any one of Aspects 45 to 46, wherein: the second EM anti-reflection layer comprises a Dk material having a Dk constant that is less than the Dk constant of the Dk material of the monolithic body.
Aspect 48. The Dk polarizer of any one of Aspects 1 to 29, further comprising: at least one plurality of Dk spacers monolithically connected to and disposed: on the bottom of more than one of the plurality of linear elongated ribs; on top of the plurality of connecting bridges and disposed vertically over, in the Z-direction, more than one of the plurality of linear elongated ribs; or, on the bottom of more than one of the plurality of linear elongated ribs, and on top of the plurality of connecting bridges and disposed vertically over, in the Z-direction, more than one of the plurality of linear elongated ribs; and at least one EM anti-reflection layer connected to the at least one plurality of Dk spacers.
Aspect 49. The Dk polarizer of Aspect 48, wherein: the at least one plurality of Dk spacers comprises a first plurality of Dk spacers monolithically connected to and disposed on the bottom of more than one of the plurality of linear elongated ribs; and the at least one EM anti-reflection layer comprises a third EM anti-reflection layer connected to and disposed on the bottom of the first plurality of Dk spacers.
Aspect 50. The Dk polarizer of Aspect 49, wherein: the third EM anti-reflection layer covers an entire outside X-Y area of the monolithic body as viewed from a plan view of the monolithic body.
Aspect 51. The Dk polarizer of any one of Aspects 49 to 50, wherein: the third EM anti-reflection layer comprises a Dk material having a Dk constant that is less than the Dk constant of the Dk material of the monolithic body.
Aspect 52. The Dk polarizer of any one of Aspects 48 to 51, wherein: the at least one plurality of Dk spacers comprises a second plurality of Dk spacers monolithically connected to and disposed on top of the plurality of connecting bridges and disposed vertically over, in the Z-direction, more than one of the plurality of linear elongated ribs; and the at least one EM anti-reflection layer comprises a fourth EM anti-reflection layer connected to and disposed on top of the second plurality of Dk spacers.
Aspect 53. The Dk polarizer of Aspect 52, wherein: the fourth EM anti-reflection layer covers an entire outside X-Y area of the monolithic body as viewed from a plan view of the monolithic body.
Aspect 54. The Dk polarizer of any one of Aspects 52 to 53, wherein: the fourth EM anti-reflection layer comprises a Dk material having a Dk constant that is less than the Dk constant of the Dk material of the monolithic body.
Aspect 55. The Dk polarizer of any one of Aspects 1 to 29, further comprising: at least one plurality of Dk spacers connected to and disposed: on the bottom of more than one of the plurality of linear elongated ribs; on top of the plurality of connecting bridges and disposed vertically over, in the Z-direction, more than one of the plurality of linear elongated ribs; or, on the bottom of more than one of the plurality of linear elongated ribs, and on top of the plurality of connecting bridges and disposed vertically over, in the Z-direction, more than one of the plurality of linear elongated ribs; and at least one EM anti-reflection layer monolithically connected to the at least one plurality of Dk spacers.
Aspect 56. The Dk polarizer of Aspect 55, wherein: the at least one plurality of Dk spacers comprises a third plurality of Dk spacers connected to and disposed on the bottom of more than one of the plurality of linear elongated ribs; and the at least one EM anti-reflection layer comprises a fifth EM anti-reflection layer monolithically connected to and disposed on the bottom of the third plurality of Dk spacers.
Aspect 57. The Dk polarizer of Aspect 56, wherein: the fifth EM anti-reflection layer covers an entire outside X-Y area of the monolithic body as viewed from a plan view of the monolithic body.
Aspect 58. The Dk polarizer of any one of Aspects 56 to 57, wherein: the fifth EM anti-reflection layer comprises a Dk material having a Dk constant that is less than the Dk constant of the Dk material of the monolithic body.
Aspect 59. The Dk polarizer of any one of Aspects 55 to 58, wherein: the at least one plurality of Dk spacers comprises a fourth plurality of Dk spacers connected to and disposed on top of the plurality of connecting bridges and disposed vertically over, in the Z-direction, more than one of the plurality of linear elongated ribs; and the at least one EM anti-reflection layer comprises a sixth EM anti-reflection layer monolithically connected to and disposed on top of the fourth plurality of Dk spacers.
Aspect 60. The Dk polarizer of Aspect 59, wherein: the sixth EM anti-reflection layer covers an entire outside X-Y area of the monolithic body as viewed from a plan view of the monolithic body.
Aspect 61. The Dk polarizer of any one of Aspects 59 to 60, wherein: the sixth EM anti-reflection layer comprises a Dk material having a Dk constant that is less than the Dk constant of the Dk material of the monolithic body.
Aspect 62. The Dk polarizer of any one of Aspects 1 to 29, further comprising: at least one plurality of Dk spacers connected to and disposed: on the bottom of more than one of the plurality of linear elongated ribs, wherein each Dk spacer of the at least one plurality of Dk spacers bridges across at least two adjacent ones of the plurality of linear elongated ribs; on top of the plurality of connecting bridges and disposed vertically over, in the Z-direction, more than one of the plurality of linear elongated ribs; or, on the bottom of more than one of the plurality of linear elongated ribs, wherein each Dk spacer of the at least one plurality of Dk spacers bridges across at least two adjacent ones of the plurality of linear elongated ribs, and on top of the plurality of connecting bridges and disposed vertically over, in the Z-direction, more than one of the plurality of linear elongated ribs; and at least one EM anti-reflection layer connected to the at least one plurality of Dk spacers.
Aspect 63. The Dk polarizer of Aspect 62, wherein: the at least one plurality of Dk spacers comprises a fifth plurality of Dk spacers connected to and disposed on the bottom of more than one of the plurality of linear elongated ribs, wherein each one of the fifth plurality of Dk spacers comprises foam; and the at least one EM anti-reflection layer comprises a seventh EM anti-reflection layer connected to and disposed on the bottom of the fifth plurality of Dk spacers.
Aspect 64. The Dk polarizer of Aspect 63, wherein: each one of the fifth plurality of Dk spacers bridges across at least two adjacent ones of the plurality of linear elongated ribs.
Aspect 65. The Dk polarizer of any one of Aspects 63 to 64, wherein: the seventh EM anti-reflection layer covers an entire outside X-Y area of the monolithic body as viewed from a plan view of the monolithic body.
Aspect 66. The Dk polarizer of any one of Aspects 63 to 65, wherein: the seventh EM anti-reflection layer comprises a Dk material having a Dk constant that is less than the Dk constant of the Dk material of the monolithic body.
Aspect 67. The Dk polarizer of any one of Aspects 62 to 66, wherein: the at least one plurality of Dk spacers comprises a sixth plurality of Dk spacers connected to and disposed on top of the plurality of connecting bridges and disposed vertically over, in the Z-direction, more than one of the plurality of linear elongated ribs; and the at least one EM anti-reflection layer comprises an eighth EM anti-reflection layer connected to and disposed on top of the sixth plurality of Dk spacers.
Aspect 68. The Dk polarizer of Aspect 67, wherein: each one of the sixth plurality of Dk spacers bridges across at least two adjacent ones of the plurality of linear elongated ribs.
Aspect 69. The Dk polarizer of any one of Aspects 67 to 68, wherein: the sixth plurality of Dk spacers comprises foam.
Aspect 70. The Dk polarizer of any one of Aspects 67 to 69, wherein: the eighth EM anti-reflection layer covers an entire outside X-Y area of the monolithic body as viewed from a plan view of the monolithic body.
Aspect 71. The Dk polarizer of any one of Aspects 67 to 70, wherein: the eighth EM anti-reflection layer comprises a Dk material having a Dk constant that is less than the Dk constant of the Dk material of the monolithic body.
Aspect 72. The Dk polarizer of any one of Aspects 1 to 29, further comprising: at least one Dk spacer layer connected to and disposed: on the bottom of the more than one plurality of linear elongated ribs, and bridging across multiple adjacent ones of the plurality of linear elongated ribs; on top of the plurality of connecting bridges, and bridging across multiple adjacent ones of the plurality of linear elongated ribs; or, on the bottom of the more than one plurality of linear elongated ribs, and bridging across multiple adjacent ones of the plurality of linear elongated ribs, and on top of the plurality of connecting bridges, and bridging across multiple adjacent ones of the plurality of linear elongated ribs; and at least one EM anti-reflection layer connected to and disposed on the at least one Dk spacer.
Aspect 73. The Dk polarizer of Aspect 72, wherein: the at least one Dk spacer layer comprises a first Dk spacer layer connected to and disposed on the bottom of the more than one plurality of linear elongated ribs, the first Dk spacer layer bridging across multiple adjacent ones of the plurality of linear elongated ribs; and the at least one EM anti-reflection layer comprises a ninth EM anti-reflection layer connected to and disposed on the bottom of the first Dk spacer layer.
Aspect 74. The Dk polarizer of Aspect 73, wherein: the first Dk spacer layer comprises foam.
Aspect 75. The Dk polarizer of any one of Aspects 73 to 74, wherein: the first Dk spacer layer and the ninth EM anti-reflection layer each cover an entire outside X-Y area of the monolithic body as viewed from a plan view of the monolithic body.
Aspect 76. The Dk polarizer of any one of Aspects 73 to 75, wherein: the ninth EM anti-reflection layer comprises a Dk material having a Dk constant that is less than the Dk constant of the Dk material of the monolithic body.
Aspect 77. The Dk polarizer of any one of Aspects 72 to 76, wherein: the at least one Dk spacer layer comprises a second Dk spacer layer connected to and disposed on top of the plurality of connecting bridges, the second Dk spacer layer bridging across multiple adjacent ones of the plurality of linear elongated ribs; and the at least one EM anti-reflection layer comprises a tenth EM anti-reflection layer connected to and disposed on top of the second Dk spacer layer.
Aspect 78. The Dk polarizer of Aspect 77, wherein: the second Dk spacer layer comprises foam.
Aspect 79. The Dk polarizer of any one of Aspects 77 to 78, wherein: the second Dk spacer layer and the tenth EM anti-reflection layer each cover an entire outside X-Y area of the monolithic body as viewed from a plan view of the monolithic body.
Aspect 80. The Dk polarizer of any one of Aspects 77 to 79 wherein: the tenth EM anti-reflector layer comprises a Dk material having a Dk constant that is less than the Dk constant of the Dk material of the monolithic body.
Aspect 81. The Dk polarizer of any one of Aspects 1 to 29, further comprising: at least one Dk support frame disposed around an outer perimeter of the monolithic body and being monolithically formed with the plurality of connecting bridges, the at least one Dk support frame: extending down below a distal end of the plurality of linear elongated ribs; extending above the plurality of connecting bridges; or, extending down below a distal end of the plurality of linear elongated ribs, and extending above the plurality of connecting bridges; and at least one EM anti-reflection layer connected to the at least one Dk support frame.
Aspect 82. The Dk polarizer of Aspect 81, wherein: the at least one Dk support frame comprises a first Dk support frame disposed around an outer perimeter of the monolithic body and being monolithically formed with the plurality of connecting bridges, the first Dk support frame extending down below a distal end of the plurality of linear elongated ribs; and the at least one EM anti-reflection layer comprise an eleventh EM anti-reflection layer connected to and disposed on the bottom of the first Dk support frame.
Aspect 83. The Dk polarizer of Aspect 82, wherein: the eleventh EM anti-reflection layer covers an entire outside X-Y area of the monolithic body as viewed from a plan view of the monolithic body.
Aspect 84. The Dk polarizer of any one of Aspects 82 to 83, wherein: the eleventh EM anti-reflector layer comprises a Dk material having a Dk constant that is less than the Dk constant of the Dk material of the monolithic body.
Aspect 85. The Dk polarizer of any one of Aspects 81 to 84, wherein: the at least one Dk support frame comprises a second Dk support frame disposed around an outer perimeter of the monolithic body and being monolithically formed with the plurality of connecting bridges, the second Dk support frame extending above the plurality of connecting bridges; and the at least one EM anti-reflection layer comprises a twelfth EM anti-reflection layer connected to and disposed on the top of the second Dk support frame.
Aspect 86. The Dk polarizer of Aspect 85, wherein: the twelfth EM anti-reflection layer covers an entire outside X-Y area of the monolithic body as viewed from a plan view of the monolithic body.
Aspect 87. The Dk polarizer of any one of Aspects 85 to 86, wherein: the twelfth EM anti-reflector layer comprises a Dk material having a Dk constant that is less than the Dk constant of the Dk material of the monolithic body.
Aspect 88. The Dk polarizer of any one of Aspects 1 to 87 that is operational at a defined frequency having an associated wavelength k, wherein: a distance in the X-direction from the center of one of the plurality of linear elongated ribs to the center of an adjacent one of the plurality of linear elongated ribs defines a unit cell dimension, wherein the unit cell dimension is equal to or less than λ/2.
Aspect 89. The Dk polarizer of any one of Aspects 1 to 88, wherein: at least the plurality of linear elongated ribs, and the plurality of connecting bridges, are features of the monolithic body that are structurally configured to be producible by a single-axis mold that closes and opens along the Z-direction.
Aspect 90. The Dk polarizer of any one of Aspects 1 to 89, wherein: each rib of the plurality of linear elongated ribs has a draft angle that drafts inward from the second side to the first side of the thickness T of the monolithic body.
Aspect 91. The Dk polarizer of Aspect 90, wherein: the draft angle is equal to or greater than 0.5-degrees and equal to or less than 5-degrees.
Aspect 92. A method of making a Dk polarizer of any one of Aspects 1 to 91, the method comprising: molding the monolithic body via a single-axis mold that closes and opens along the Z-direction.
Aspect 93. A Dk polarizer assembly, comprising: a plurality of the Dk polarizer of any one of Aspects 1 to 91.
Aspect 94. The Dk polarizer assembly of Aspect 93, wherein: the plurality of Dk polarizers are arranged side-by-side one another in a tiled arrangement.
Aspect 95. The Dk polarizer assembly of Aspect 94, wherein: the tiled arrangement is a planar tiled arrangement.
Aspect 96. The Dk polarizer assembly of any one of Aspects 93 to 95, wherein: the plurality of linear elongated ribs of each of the plurality of Dk polarizers are aligned in a same direction.
Aspect 97. The Dk polarizer assembly of any one of Aspects 93 to 96, wherein: each monolithic body of each of the plurality of Dk polarizers has its corresponding overall thickness dimension, T, aligned in the Z-direction.

1. A dielectric, Dk, polarizer for electromagnetic, EM, applications, the Dk polarizer comprising:
a monolithic body of Dk material comprising a plurality of linear elongated ribs that are disposed parallel with each other and that are uniformly spaced apart with respect to each other;
wherein each rib of the plurality of linear elongated ribs has a cross section x-z profile relative to an orthogonal X-Y-Z coordinate system associated with the monolithic body;
wherein the Y-direction of the coordinate system is oriented in a direction of elongation of the plurality of linear elongated ribs;
wherein the Z-direction of the coordinate system is oriented in a direction of propagation of an EM wave, when present at the Dk polarizer, through the uniformly spaced apart plurality of linear elongated ribs;
wherein the monolithic body has an overall thickness dimension, T, aligned in the Z-direction, that extends from a first side to a second side of the body, the second side being at dimension T relative to the first side;
wherein adjacent ones of the plurality of linear elongated ribs are monolithically connected to each other by a plurality of connecting bridges;
wherein the plurality of connecting bridges are disposed at a location equal to or greater than T/2 and equal to or less than T.

2. The Dk polarizer of claim 1, wherein:
the plurality of connecting bridges comprise a first plurality of the connecting bridges disposed at or proximate to the first side of the body, and a second plurality of the connecting bridges disposed at or proximate to the second side of the body.

3. The Dk polarizer of claim 1, wherein:
at least one of the plurality of linear elongated ribs comprises at least one region having an expanded x-z cross section in conjunction with an expanded x-y cross section relative to x-z and x-y cross sections of a non-expanded region of a corresponding linear elongated rib.

4. The Dk polarizer of claim 1, wherein:
each connecting bridge of the plurality of connecting bridges has an x-z cross section that is relatively thin in the Z-direction as compared to the x-z cross section of an associated linear elongated rib in the Z-direction.

5. The Dk polarizer of claim 1, wherein:
the plurality of connecting bridges are disposed between, and uniformly spaced apart along a length of, adjacent ones of the plurality of linear elongated ribs; and
adjacent ones of the plurality of connecting bridges, and adjacent ones of the plurality of linear elongated ribs, form voids through the monolithic body in the Z-direction.

6. The Dk polarizer of claim 1, wherein:
the plurality of connecting bridges form a solid surface at the second side of the thickness, T, the solid surface being absent of voids through the monolithic body in the Z-direction.

7. The Dk polarizer of claim 1, wherein:
the monolithic body is formed completely of a Dk material.

8. The Dk polarizer of claim 1, wherein:
each end of the plurality of linear elongated ribs is open-ended, in that each respective end is not connected to a corresponding end of an adjacent one of the plurality of linear elongated ribs.

9. The Dk polarizer of claim 1, wherein:
each end of the plurality of linear elongated ribs is at least partially close-ended, in that each respective end of the plurality of linear elongated ribs is monolithically connected to a corresponding end of an adjacent one of the plurality of linear elongated ribs.

10. The Dk polarizer of claim 1, wherein:
the plurality of connecting bridges form a frame at an outer periphery of the monolithic body, and are monolithically connected to respective ends of adjacent ones of the plurality of linear elongated ribs.

11. The Dk polarizer of claim 10, wherein:
each one of the plurality of connecting bridges has a height in the Z-direction that is equal to the overall thickness, T, of the monolithic body.

12. The Dk polarizer of claim 11, wherein:
the plurality of connecting bridges, and adjacent ones of the plurality of linear elongated ribs, form voids through the monolithic body in the Z-direction; and
the voids are present between adjacent ones of the plurality of linear elongated ribs, and run the length of the associated adjacent ribs.

13. The Dk polarizer of claim 1, further comprising:
at least one plurality of EM anti-reflection features monolithically connected to and disposed: on the bottom of the plurality of linear elongated ribs; on the top of the plurality of linear elongated ribs; or, on both the bottom and the top of the plurality of linear elongated ribs.

14. The Dk polarizer of claim 13, wherein:
the at least one plurality of EM anti-reflection features comprises a first plurality of EM anti-reflection features monolithically connected to and disposed on the bottom of the plurality of linear elongated ribs.

15. The Dk polarizer of claim 14, wherein:
each EM anti-reflection feature of the first plurality of EM anti-reflection features comprises a projection having an x-z cross section that is smaller in both the x-direction and the z-direction than the x-z cross section of the corresponding linear elongated rib.

16. The Dk polarizer of claim 14, wherein:
the at least one plurality of EM anti-reflection features comprises a second plurality of EM anti-reflection features are monolithically connected to and disposed on top of the plurality of connecting bridges and disposed vertically over, in the Z-direction, the plurality of linear elongated ribs.

17. The Dk polarizer of claim 16, wherein:
each EM anti-reflection feature of the second plurality of EM anti-reflection features comprises a projection having an x-z cross section that is smaller in the z-direction than that of the x-z-cross section of the corresponding linear elongated rib, and wherein adjacent ones of the second plurality of EM anti-reflection features do not directly touch each other.

18. The Dk polarizer of claim 1 that is operational at a defined frequency having an associated wavelength k, wherein:
a distance in the X-direction from the center of one of the plurality of linear elongated ribs to the center of an adjacent one of the plurality of linear elongated ribs defines a unit cell dimension, wherein the unit cell dimension is equal to or less than λ/2.

19. A Dk polarizer assembly, comprising:
a plurality of the Dk polarizer of claim 1.

20. The Dk polarizer assembly of claim 19, wherein:
the plurality of Dk polarizers are arranged side-by-side one another in a tiled arrangement.

21. The Dk polarizer assembly of claim 20, wherein:
the tiled arrangement is a planar tiled arrangement.

22. The Dk polarizer assembly of claim 19, wherein:
the plurality of linear elongated ribs of each of the plurality of Dk polarizers are aligned in a same direction.

23. The Dk polarizer assembly of claim 19, wherein:
each monolithic body of each of the plurality of Dk polarizers has its corresponding overall thickness dimension, T, aligned in the Z-direction.
